(19) United States
(12) Patent Application Publication
(10) Pub. No.: US 2026/0277949 A1
(43) Pub. Date: Sep. 17, 2026

(54) ORCHESTRATING A MIXTURE OF EXPERTS FOR CONVERSATIONAL AI SYSTEMS AND APPLICATIONS

(71) Applicant: NVIDIA Corporation, Santa Clara, CA (US)

(72) Inventors: Lu An, Queen Creek, AZ (US); Anbang Xu, San Jose, CA (US); Rama Akkiraju, Cupertino, CA (US); Di Xu, Mountain View, CA (US); Deepak Bora, San Ramon, CA (US); Tan Yu, San Jose, CA (US); Sidney Knowles, Campbell, CA (US); Ashok Marannan, San Jose, CA (US); Sean Javiya, San Jose, CA (US); Meghana Puvvadi, San Jose, CA (US); Abhinav Balasubramanian, Milpitas, CA (US); Yang Jiao, Mountain View, CA (US); Aaditya Ramshankar Shukla, Fremont, CA (US); Lei Yang, San Jose, CA (US); Amanda Burgmeier, Saratoga, CA (US); Divyanshi Yadav, Milpitas, CA (US); Hridhay Mehta, San Jose, CA (US); Vishal Seth, Milpitas, CA (US); Tamar Bar, Los Altos Hills, CA (US); Jasmine Jaksic, Mountain View, CA (US); Vishnu Vardhaanan Leelakrishnan, Union City, CA (US); Paramaguru Muthusamy, Fremont, CA (US); Ashwinikumar Binodnath Jha, Morgan Hill, CA (US); Murali Maram, Pleasanton, CA (US)

(21) Appl. No.: 19/080,576

(22) Filed: Mar. 14, 2025

(51) Int. Cl. G06F 16/3329; G06N 5/043; H04L 51/02

(52) U.S. Cl. CPC G06F 16/33295; G06N 5/043; H04L 51/02

(57) ABSTRACT

In various examples, methods, systems, processors, and/or machine-readable mediums implement a conversational artificial intelligence (AI) that obtains results from other conversational AIs, and generates output based at least on those results. In at least one embodiment, an orchestrator conversational AI receives input(s), and uses one or more strategies to obtain one or more results from one or more expert conversational AIs based in part on one or more inputs received by the orchestrator conversational AI, and determines at least one response to the one or more inputs based at least on a portion of the one or more results.

### BACKGROUND

A conversational artificial intelligence (AI), such as a chatbot, may simulate conversation with a human user. A conversational AI may be constructed to respond to queries related to information associated with particular topics, and/or information that was stored by one or more systems and/or one or more services. However, generating an answer to some questions may use excessive resources if, for example, a conversation AI does not have access to relevant information. As such, an amount of memory, time, and/or other computing resources used to generate answers can be improved.

### SUMMARY

Embodiments of the present disclosure relate to a conversational artificial intelligence (AI) to orchestrate mixture of expert (MoE) conversational AIs—e.g., chatbots. Systems and methods are disclosed that orchestrate a process of obtaining one or more answers to one or more questions (e.g., presented in one or more prompts) from one or more neural networks.

In contrast to conventional systems, an orchestrator may select one or more different strategies for using the expert conversational AIs to generate results that the orchestrator may use to generate one or more responses to input (e.g., one or more queries) presented to the orchestrator by one or more requestors (e.g., one or more users and/or one or more automated processes).

### BRIEF DESCRIPTION OF THE DRAWINGS

The present systems and methods for a conversational artificial intelligence (AI) to orchestrate mixture of expert conversational Als are described in detail below with reference to the attached drawing figures, wherein:

FIG. 1 is a block diagram illustrating an example system suitable for use in implementing at least some embodiments of the present disclosure;

FIG. 2 is a block diagram illustrating an example orchestrator agent using one or more strategies to determine a set of expert agents to provide results in response to one or more inputs, in accordance with some embodiments of the present disclosure;

FIG. 3 is a block diagram illustrating an example system to implement the orchestrator agent illustrated in FIG. 2, in accordance with some embodiments of the present disclosure;

FIG. 4 is a block diagram illustrating an example system that implements an orchestrator that uses experts to perform information retrieval, in accordance with some embodiments of the present disclosure;

FIG. 5A is a flow diagram illustrating the method of using an orchestrator to obtain output in response to one or more inputs, in accordance with some embodiments of the present disclosure;

FIG. 5B is a flow diagram illustrating a method of implementing a pre-facto expert selection strategy, in accordance with some embodiments of the present disclosure;

FIG. 6 is a flow diagram illustrating a method of implementing an intra-expert post-retrieval early termination strategy, in accordance with some embodiments of the present disclosure;

FIG. 7 is a flow diagram illustrating a method of implementing an inter-expert post-retrieval early termination strategy, in accordance with some embodiments of the present disclosure;

FIG. 8 is a block diagram illustrating a processor and storage to use in implementing at least some embodiments of the present disclosure;

FIG. 9A is a block diagram of an example generative language model system suitable for use in implementing at least some embodiments of the present disclosure;

FIG. 9B is a block diagram of an example generative language model that includes a transformer encoder-decoder suitable for use in implementing at least some embodiments of the present disclosure;

FIG. 9C is a block diagram of an example generative language model that includes a decoder-only transformer architecture suitable for use in implementing at least some embodiments of the present disclosure;

FIG. 10 is a block diagram of an example computing device suitable for use in implementing at least some embodiments of the present disclosure; and

FIG. 11 is a block diagram of an example data center suitable for use in implementing at least some embodiments of the present disclosure.

### DETAILED DESCRIPTION

Systems and methods are disclosed related to conversational artificial intelligence (AI) to orchestrate mixture of expert conversational AIs—such as chatbots, digital avatars, virtual assistants, and/or the like.

A conversational AI may be considered to be an expert with respect to information retrievable by the conversational AI. Different conversational AIs may be constructed to respond to queries with respect to different information (e.g., stored by different system(s) and/or service(s)), and may be experts with respect to such information. The areas of expertise of different experts may be characterized as having a scope and the scopes of two or more experts may overlap. For example, an organization might use a first chatbot to answer human resources questions, and a different second chatbot to answer questions related to company logistics. The scopes of these experts overlap, for example, with respect to company holidays, which affect both employee benefits and company logistics. Some types of information are spread between two or more experts, and/or may be inferred from what one or more of the experts know. To obtain such types of information, a determination must be made as to which expert(s) alone or in combination might be able to produce relevant information, possibly ask two or more experts separate questions, and potentially combine multiple answers from different experts.

A conversational AI (e.g., one or more neural networks, such as one or more language models), referred to as an orchestrator, may receive one or more prompts or queries (e.g., in natural language), implement one or more strategies to obtain result(s) from one or more experts (conversational AIs), and output an answer to the query(ies) based on the result(s) obtained from the expert(s). The strategy(ies) may include a post-facto expert selection strategy, a pre-facto expert selection strategy, an intra-expert post-retrieval early termination strategy, and/or an inter-expert post-retrieval termination strategy. The orchestrator decides which of the strategies to apply, and oversees their implementation. By way of a non-limiting example, a conversational AI may be implemented using one or more language models (LM(s)), which may include one or more large language models (LLM(s)), one or more small language models (SLM(s)), one or more vision language models (VLM(s)), one or more multi-modal language model (MMLM(s)), etc.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software. At least a portion of the orchestrator (e.g., neural networks used to implement the orchestrator) may be implemented at least in part using one or more microservices, such as one or more inference microservices. At least a portion of one or more of the experts (e.g., neural networks used to implement at least one of the experts) may be implemented at least in part using one or more microservices, such as one or more inference microservices.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, SLM, VLM, MMLM, diffusion model, transformer model, NeRF, DNN, etc.) and/or the image database hosted on the local and/or remote servers using one or more APIs—such as, without limitation, REST APIs. At least a portion of the orchestrator (e.g., an interface used to implement the orchestrator) may be implemented at least in part using one or more talking or smart kiosk applications. At least a portion of one or more of the experts (e.g., an interface used to implement at least one of the experts) may be implemented at least in part using one or more talking or smart kiosk applications. The requestor(s) 103 may use one or more talking or smart kiosk applications to provide the input(s) to the orchestrator and/or receive or view output generated by the orchestrator.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, SLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used. At least a portion of the orchestrator (e.g., an interface used to implement the orchestrator) may be implemented at least in part using one or more gaming application. At least a portion of one or more of the experts (e.g., an interface used to implement at least one of the experts) may be implemented at least in part using one or more gaming application. The requestor(s) 103 may use one or more gaming application to provide the input(s) to the orchestrator and/or receive or view output generated by the orchestrator.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, SLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used. At least a portion of the orchestrator (e.g., an interface used to implement the orchestrator) may be implemented at least in part using one or more video conferencing application. At least a portion of one or more of the experts (e.g., an interface used to implement at least one of the experts) may be implemented at least in part using one or more video conferencing application. The requestor(s) 103 may use one or more video conferencing application to provide the input(s) to the orchestrator and/or receive or view output generated by the orchestrator.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, SLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers). At least a portion of the orchestrator (e.g., an interface used to implement the orchestrator) may be implemented at least in part using one or more robotics application. At least a portion of one or more of the experts (e.g., an interface used to implement at least one of the experts) may be implemented at least in part using one or more robotics application. The requestor(s) 103 may use one or more robotics application to provide the input(s) to the orchestrator and/or receive or view output generated by the orchestrator.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time. At least a portion of the orchestrator (e.g., an interface used to implement the orchestrator) may be implemented at least in part using an IVI system and/or IX application. At least a portion of one or more of the experts (e.g., an interface used to implement at least one of the experts) may be implemented at least in part using an IVI system and/or IX application. The requestor(s) 103 may use an IVI system and/or IX application to provide the input(s) to the orchestrator and/or receive or view output generated by the orchestrator.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), small language models (SLMs), vision language models (VLMs), multi-modal language models (MMLMs), vision-language-action (VLA) models, etc.), and/or other types of machine learning models.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using NVLink Switch) and tensor cores (which enable mixed-precision computing, such as microscaling precision support), server clusters may be more capable of training enormous networks at high speeds. As such, tensor core precisions of FP64, TF32, BF16, FP16, FP8, INT8, FP6, and FP4 may be supported, as well as CUDA core precisions of FP64, FP32, FP16, and BF16.

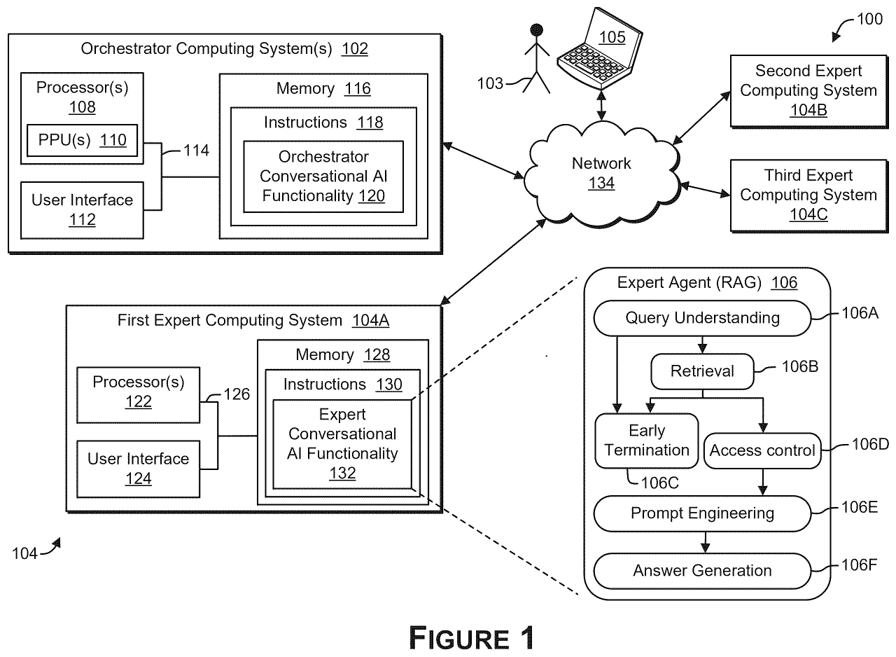

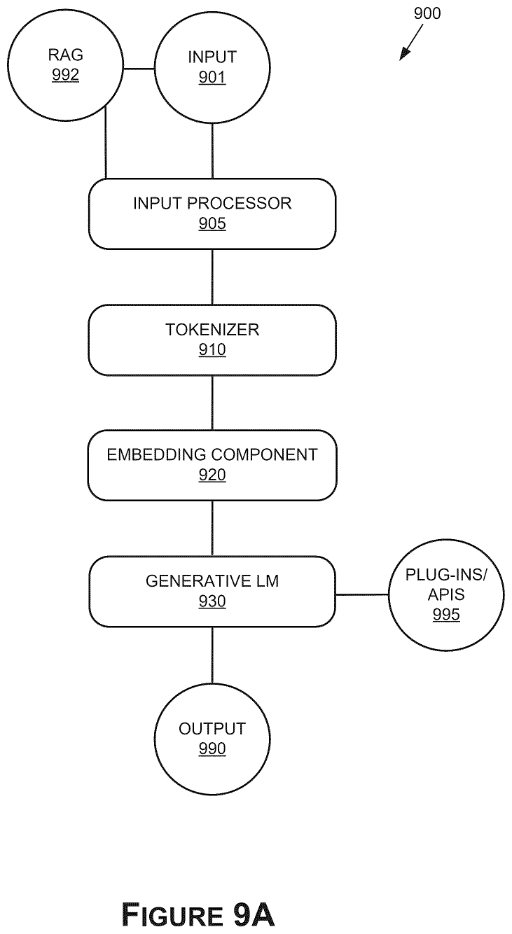

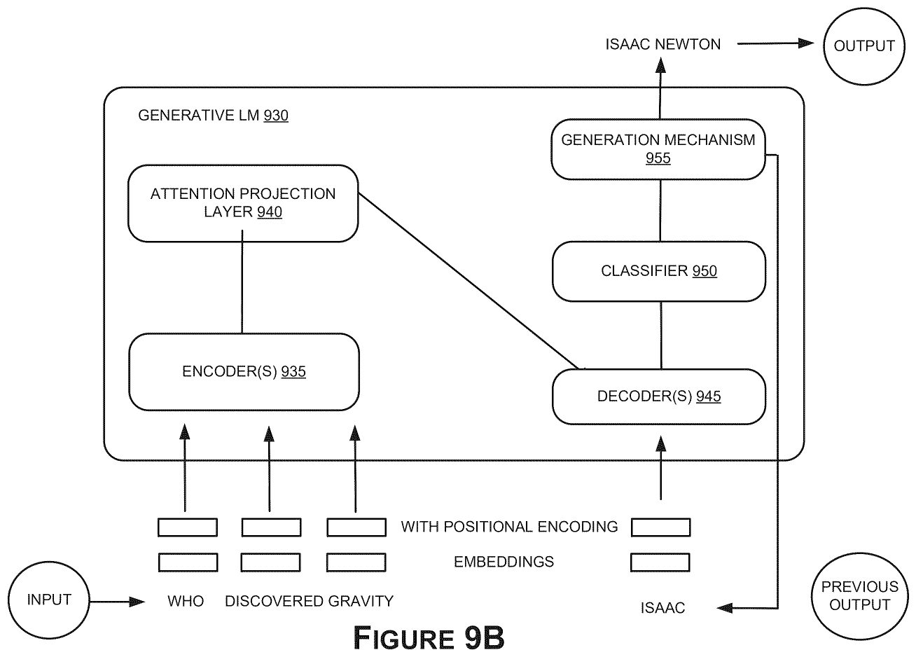

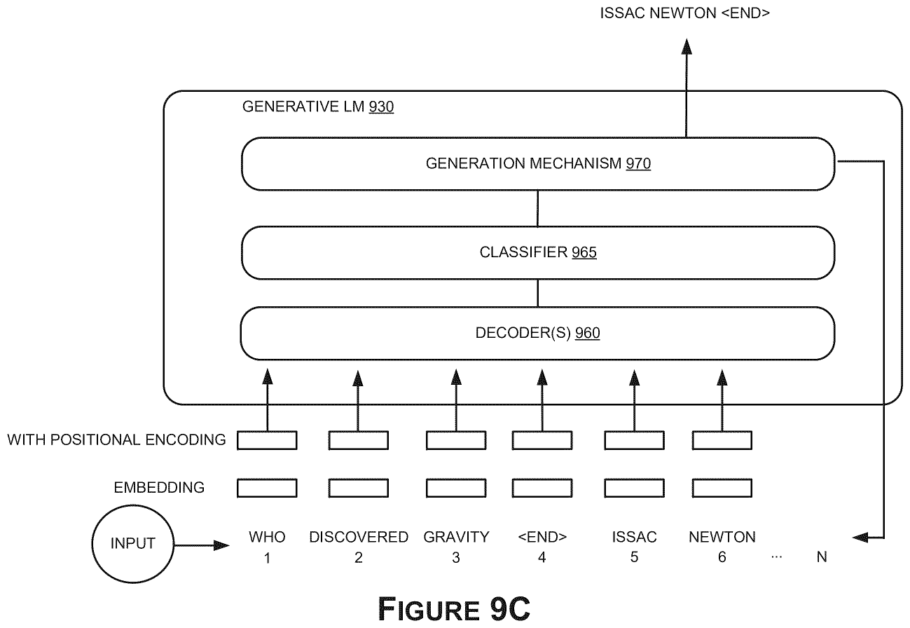

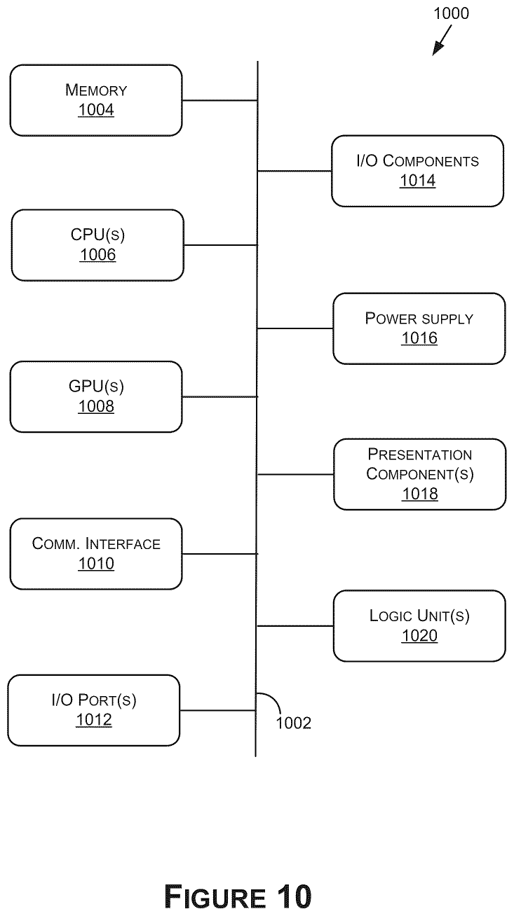

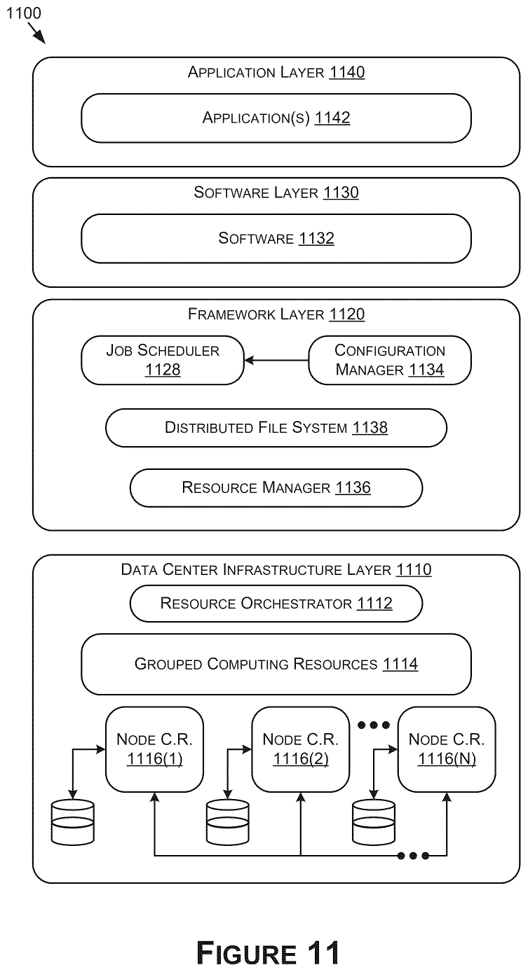

With reference to FIG. 1, FIG. 1 is a block diagram illustrating an example system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories. For example, in some embodiments, the system and methods described herein may be implemented using one or more generative language models (e.g., as described in FIGS. 9A-9C), one or more computing devices or components thereof (e.g., as described in FIG. 10), and/or one or more data centers or components thereof (e.g., as described in FIG. 11).

The system 100 may include one or more orchestrator computing systems 102 that implements an orchestrator conversational AI (referred to as an orchestrator or an orchestrator agent), one or more expert computing systems 104 that implement(s) two or more expert conversational AIs (referred to as an expert or an expert agents), and/or one or more client computing devices 105. However, in some embodiments, the orchestrator agent and the expert agents may be implemented by the same computing system. In at least one embodiment, one or more of the orchestrator computing system(s) 102, one or more of the expert computing system(s) 104, and/or one or more of the client computing device(s) 105 may be implemented by the same computing system. In FIG. 1, the expert computing system(s) 104 have been illustrated as including three expert computing systems 104A-104C. However, the expert computing system(s) 104 may include any number of expert computing systems, including a single expert computing system. In at least one embodiment, at least a portion of one or more of the orchestrator computing system(s) 102, at least a portion of one or more of the expert computing system(s) 104, and/or at least a portion of one or more of the client computing device(s) 105 is/are implemented using at least a portion of any system(s) depicted in and/or described with respect to FIGS. 9-11. In at least one embodiment, at least a portion of one or more of the orchestrator computing system(s) 102, at least a portion of one or more of the expert computing system(s) 104, and/or at least a portion of one or more of the client computing device(s) 105 is/are used to implement at least a portion of any system(s) depicted in and/or described with respect to FIGS. 9-11.

The expert agents may each perform a Retrieval-Augmented Generation (RAG) process 106, in which the expert agent retrieves information (e.g., from a database, data lake, and/or other data stores) based on a query, and then provides this retrieved information as input to one or more neural networks (e.g., in a prompt to one or more LMs, such as one or more LLMs, one or more SLMs, one or more VLMs, one or more MMLMs, etc.) to use to generate an answer. Thus, the expert agents may integrate information retrieval with language generation. One or more of the expert agents may retrieve the information by accessing one or more data sources that may be implemented by one or more computing systems like the orchestrator computing system(s) 102. These data source(s) may include data (e.g., documents) stored in one or more formats and/or having one or more data types. Non-limiting examples of such data includes design information (e.g., design documents) stored in Google Docs, Confluence pages, human resource information (e.g., documents), benefits information (e.g., documents), information technology information (e.g., documents), articles, webpages, and/or other information. Each information type may include and/or be associated with different metadata, making integration complex.

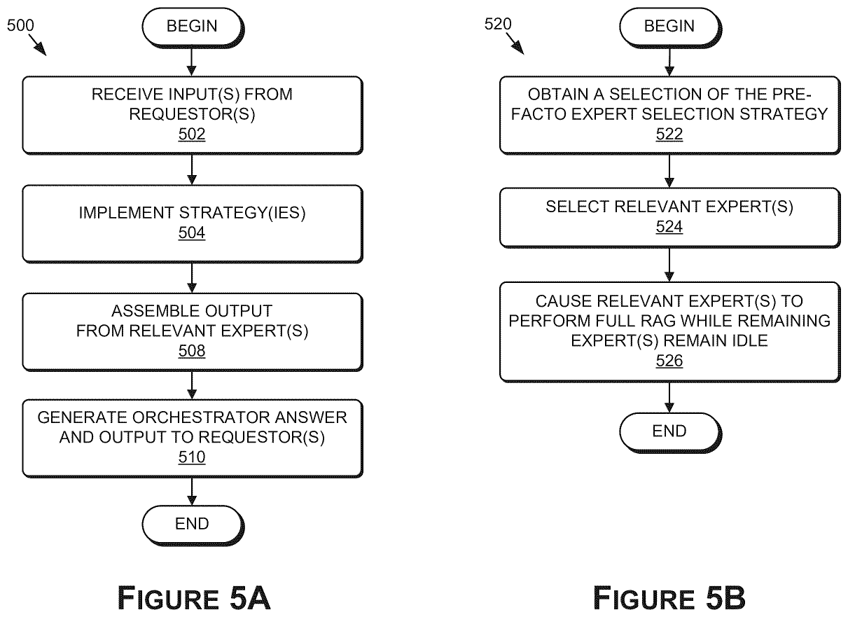

The orchestrator agent implemented by the orchestrator computing system(s) 102 receives one or more inputs (e.g., one or more prompts or queries) from one or more requestors 103 (e.g., one or more users, software, one or more machines, one or more systems, one or more AI agents, one or more automated processes, etc.), and uses the expert agents (e.g., implemented by the expert computing system(s) 104) to generate output (e.g., one or more answers to one or more questions included in the input(s)). The input(s) to the orchestrator agent and/or output generated by the orchestrator agent may include text (e.g., natural language), and/or other types of input such as audio, image(s), video(s), and/or one or more other types of contextual and/or semantic data. The orchestrator agent may use one or more strategies to cause one or more of the expert agents to generate results (e.g., the RAG process 106). The orchestrator agent may generate output in response to the input(s) based on the results obtained from the expert(s). The strategy(ies) may include a post-facto expert selection strategy, a pre-facto expert selection strategy, an intra-expert post-retrieval early termination strategy, and/or an inter-expert post-retrieval termination strategy. The orchestrator agent may decide which of the strategies to apply, and may oversee implementation of the selected strategy(ies). The orchestrator agent may determine which strategies to use based at least in part on the input(s) (e.g., prompt(s)) provided to the orchestrator agent. As an example, the orchestrator computing system(s) 102 may manage and direct workflows across multiple expert agents, each specializing in a specific knowledge domain and/or topic. The orchestrator agent may employ one or more strategies (e.g., perform one or more of methods 500, 520, 600, or 700 illustrated in FIGS. 5A, 5B, 6, and 7, respectively), such as those mentioned herein, to select one or more expert agents to produce results that are used by the orchestrator agent to generate output (e.g., one or more answers) and provide the output to the requestor(s) 103. By intelligently selecting which expert agents to engage (e.g., based at least on the input(s) to the orchestrator agent), the orchestrator agent may improve (e.g., optimize) the retrieval and processing of information, to assemble coherent and relevant output (e.g., a final answer) for the requestor(s) 103.

The orchestrator computing system(s) 102 may include one or more processors 108, a user interface 112, and/or memory 116. The processor(s) 108 may include one or more parallel processing units (“PPU(s)”) 110, such as one or more graphics processing units (“GPU(s)”), one or more massively parallel GPU(s), and/or the like. In at least one embodiment, massively parallel GPU(s) refer to a collection of one or more GPUs, or any suitable processing units, which may be utilized to perform various processes in parallel. The processor(s) 108 may be implemented, for example, using a main central processing unit (“CPU”) complex, one or more microprocessors, one or more microcontrollers, the PPU(s) 110 (e.g., GPU(s)), one or more data processing units (“DPU(s)”), one or more arithmetic logic units (“ALU(s)”), and/or the like. In at least one embodiment, at least a portion of the processor(s) 108 is implemented using at least a portion of any system(s) depicted in and/or described with respect to FIGS. 9A-11. In at least one embodiment, at least a portion of the processor(s) 108 is used to implement at least a portion of any system(s) depicted in and/or described with respect to FIGS. 9A-11.

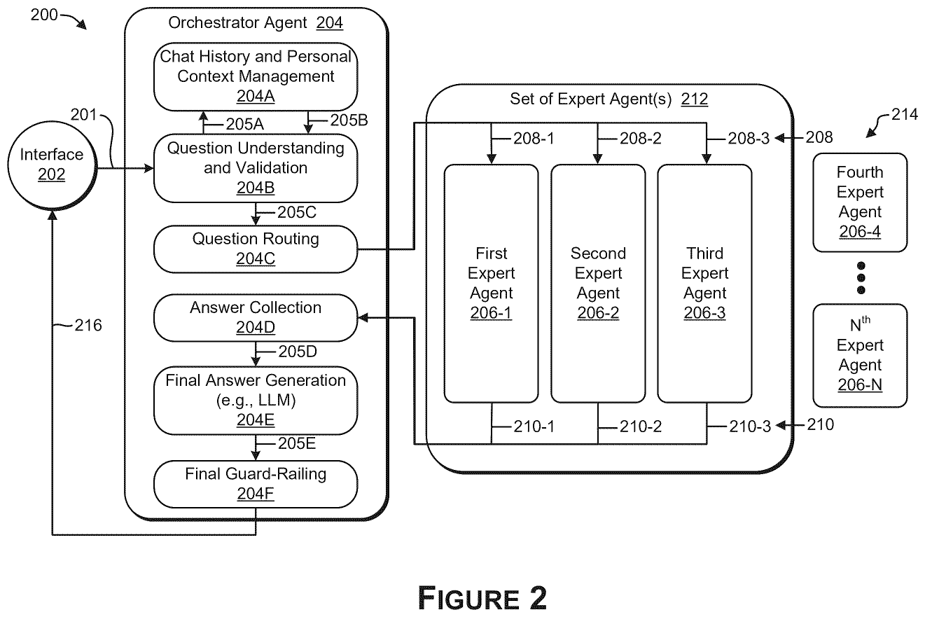

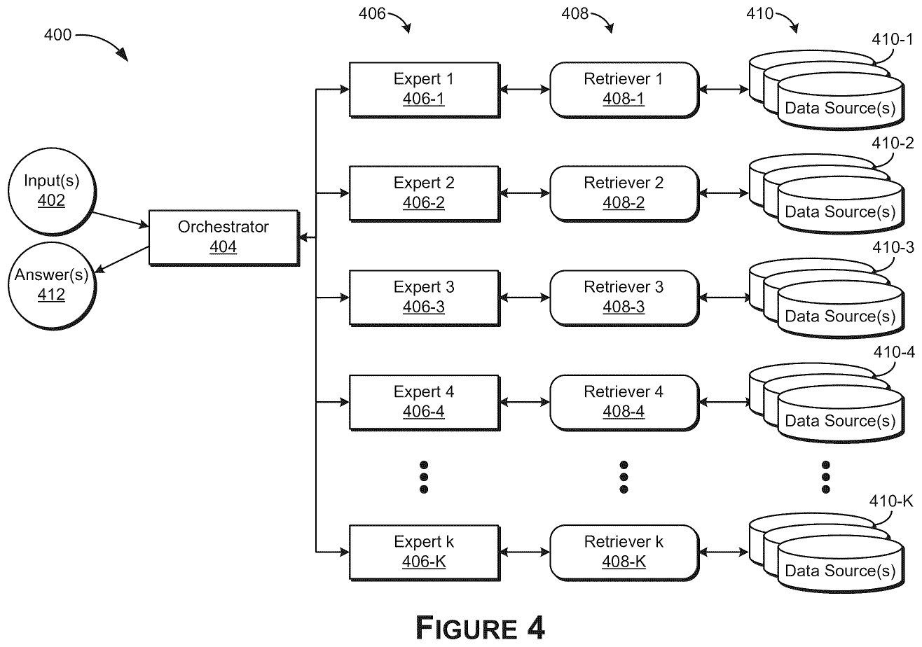

The user interface 112 may include a display device (not shown) that a user may use to view information generated and/or displayed by the orchestrator computing system(s) 102. The user may use the user interface 112 to enter user input (e.g., one or more prompts) into the orchestrator computing system(s) 102. The user interface 112 may communicate (e.g., wirelessly) with the client computing device 105 and/or one or more other user devices (e.g., a cellular telephone, a laptop computer, a tablet, and/or the like) and may receive user input from the computing device 105 and/or the other user device(s). The user interface 112 may serve as a point of interaction between one or more users and the orchestrator computing system(s) 102 and/or the expert computing system(s) 104. As an example, the user interface 112 may be used by one or more users to provide input(s) (e.g., queries) to the orchestrator computing system(s) 102, and receive output (e.g., responses), which may facilitate a seamless and intuitive user experience. The user interface 112 may receive one or more inputs from a user, such as input(s) 201 (see FIG. 2), and/or input(s) 402 (see FIG. 4). In at least one embodiment, at least a portion of the user interface 112 is implemented using at least a portion of any system(s) depicted in and/or described with respect to FIGS. 9A-11. In at least one embodiment, at least a portion of the user interface 112 is used to implement at least a portion of any system(s) depicted in and/or described with respect to FIGS. 9A-11.

The memory 116 (e.g., one or more non-transitory processor-readable medium) may store processor executable instructions 118 that when executed by the processor(s) 108 implement orchestrator conversation AI functionality 120, and/or other functionality. The processor(s) 108 may include one or more circuits that perform at least a portion of the instructions 118 stored in the memory 116. By way of additional non-limiting examples, the memory 116 (e.g., one or more non-transitory processor-readable medium) may be implemented, for example, using volatile memory (e.g., dynamic random-access memory (“DRAM”)) and/or nonvolatile memory (e.g., a hard drive, a solid-state device (“SSD”), and/or the like). As an example, the memory 116 stores data and/or instructions for processing one or more queries, generating one or more answers using one or more LMs and/or managing workflows. The memory 116 may include stored context and state information across interactions with multiple expert agents and/or the expert computing system(s) 104. The orchestrator computing system(s) 102 may store information retrieved by one or more of the expert agents (e.g., implemented by the expert computing system(s) 104), and/or relevance metrics calculated by the expert agents in the memory 116. In at least one embodiment, at least a portion of the memory 116 is implemented using at least a portion of any system(s) depicted in and/or described with respect to FIGS. 9A-11. In at least one embodiment, at least a portion of the memory 116 is used to implement at least a portion of any system(s) depicted in and/or described with respect to FIGS. 9A-11.

The processor(s) 108, the user interface 112, and/or the memory 116 may communicate with one another over one or more connections 114, such as a bus, a Peripheral Component Interconnect Express (“PCIe”) connection (or bus), and/or the like. In at least one embodiment, at least a portion of the connection(s) 114 is implemented using at least a portion of any system(s) depicted in and/or described with respect to FIGS. 9A-11. In at least one embodiment, at least a portion of the connection(s) 218 is used to implement at least a portion of any system(s) depicted in and/or described with respect to FIGS. 9A-11.

In at least one embodiment, the orchestrator conversational AI functionality 120 implements one or more strategies to determine which of the expert agents (e.g., implemented by the expert computing system(s) 104) is/are to provide one or more responses to the orchestrator agent, which generates output responsive to input supplied by the requestor(s) 103. As an example, the orchestrator agent may select from one or more strategies that include a post-facto expert selection strategy, a pre-facto expert selection strategy, an intra-expert post-retrieval early termination strategy, and/or an inter-expert post-retrieval termination strategy.

The post-facto expert selection strategy may involve the orchestrator agent instructing each of the expert agents to perform a full RAG process, and provide the results to the orchestrator agent, which may rank and/or aggregate the results to generate an output (e.g., an answer). The orchestrator agent may omit any results determined by the orchestrator agent as not being relevant (e.g., results ranked below a threshold value, or any results associated with a confidence value below a threshold value). Though this strategy may provide higher quality answers than other strategies, it may also have greater latency.

The pre-facto expert selection strategy may involve the orchestrator agent selecting one or more of the expert agents relevant to the input(s) provided by the requestor(s) 103 (a user query) to generate results. Any of expert agents that the orchestrator agent determines are not relevant may remain idle. After the selected expert agent(s) produce(s) results, they may provide those results to the orchestrator agent, which may assemble (e.g., aggregate) the results to generate an output (e.g., an answer). As an example, the orchestrator agent may classify input provided by the requestor(s) 103 (e.g., a query) as being relevant to a specific topic, and route the input to one or more expert agents also classified and/or identified as being associated with this topic. Example topics include human resources, finance, general, logistics, news, technologies, or legal. The orchestrator agent may be provided with a description of each expert agent that identifies a scope of expertise of the expert agent, and/or identifies that expert agent as being associated with particular topics (e.g., being able to retrieve information related to the particular topics). Sometimes, two or more expert agents may be identified as being relevant to a particular topic. In other words, a scope of expertise of two or more expert agents may overlap. In such cases, the orchestrator agent may select expert agents with overlapping scopes of expertise. The pre-facto expert selection strategy may be well suited for less complex queries, such as queries that are classified by the orchestrator agent with topics that are within the scope of a single expert agent.

The intra-expert post-retrieval early termination strategy involves the orchestrator agent selecting at least a portion of the expert agents (e.g., all of the expert agents), forwarding the input to each of the selected expert agents, and instructing each of the expert agents to retrieve information from its data store (e.g., database(s), data lake(s), and/or one or more other types of data stores), and determine whether one or more portions of information obtained are relevant to the input provided by the requestor(s) 103 (e.g., query(ies)). As an example, one or more of the expert agents may retrieve one or more portions of information. If a particular one the expert agents determines information retrieved by the particular expert is relevant to the input(s) provided by the requestor(s) 103 (e.g., query(ies)), the particular expert may generate results (e.g., using its LM(s)). Thus, an expert agent may perform a full RAG process (e.g., the RAG process 106) if the expert agent retrieved relevant information. The expert agent(s) that produced results may provide those results to the orchestrator agent, which assembles (e.g., aggregates) the results to generate output (e.g., an answer). The intra-expert post-retrieval early termination strategy may reduce computation resources used by the expert agent(s) because one or more of the expert agents may “terminate” or ends its process early, prior to performing the computationally expensive process of generating results (e.g., using its LM(s), such as one or more LLMs, one or more SLMs, one or more VLMs, one or more MMLMs, etc.).

The inter-expert post-retrieval early termination strategy involves the orchestrator agent selecting at least a portion of the expert agents (e.g., all of the expert agents), forwarding expert input(s) to each of the selected expert(s), and instructing each of the selected expert(s) to acquire information from its data store (e.g., database(s), data lake(s), and/or one or more other types of data stores), calculate one or more relevance metrics (e.g., an embedding distance between the retrieved information and expert input(s) provided to the expert), and send the relevance metric(s) to the orchestrator agent, which uses the relevance metric(s) to determine whether this information is relevant to the expert input(s) provided to the expert agent (e.g., query(ies)) by the orchestrator agent. The orchestrator agent may instruct a particular one of the selected expert(s) to generate an answer only if the orchestrator agent determines the information is relevant. Thus, the particular expert may perform the full RAG process 106 if the orchestrator agent determines the particular expert retrieved relevant information. The selected expert(s) may be instructed to produce results and provide those results to the orchestrator agent, which assembles (e.g., aggregates) the results to generate output (e.g., an answer). The inter-expert post-retrieval early termination strategy may allow the orchestrator agent to compare information (e.g., the relevance metric(s)) obtained from one or more of the expert agents jointly, and decide which of the expert agents is to terminate early or perform the full RAG process (e.g., using its LM(s)).

The processor(s) 108 may execute the instructions 118 and manage computational tasks. As an example, the processor(s) 108 may perform operations to orchestrate interactions between the expert agents and process input(s) provided by the requestor(s) 103 (e.g., user queries). In at least one embodiment, the processor(s) 108 perform(s) analysis and decision-making operations to help ensure that the most relevant expert(s) is/are engaged for each input suppled by the requestor(s) 103 (e.g., each query) and that the final output is generated efficiently.

In at least one embodiment, the system 100 includes a collection of one or more hardware and/or software computing resources with instructions that, when executed, performs one or more communication processes such as those described herein. In at least one embodiment, the system 100 is a software program executing on computer hardware, application executing on computer hardware, and/or variations thereof. In at least one embodiment, one or more processes of the system 100 are performed by any suitable processing system or unit (e.g., a GPU, general-purpose GPU (GPGPU), PPU, CPU, a DPU, and in any suitable manner, including sequential, parallel, and/or variations thereof. In at least one embodiment, the system 100 uses a machine learning training framework such as PYTORCH, TENSORFLOW, BOOST, CAFFE, MICROSOFT COGNITIVE TOOLKIT/CNTK, MXNET, CHAINER, KERAS, DEEPLEARNING4J, and/or other training framework to implement and perform operations described herein to perform a conversational artificial intelligence (AI) (e.g., the orchestrator agent, and/or one or more of the expert agents) to generate responses to input provided by the requestor(s) 103 (e.g., queries) and/or otherwise perform operations described herein. In at least one embodiment, as an example, training a neural network model (e.g., of the (e.g., the orchestrator agent, and/or one or more of the expert agents)) includes use of a server (e.g., NVIDIA DGX servers) which further includes at least a GPU (e.g., AMD MI200, VEGAL10, VEGO20, AND ARCTURUS), an optimizer (e.g., ADAM OPTIMIZER), or discriminator.

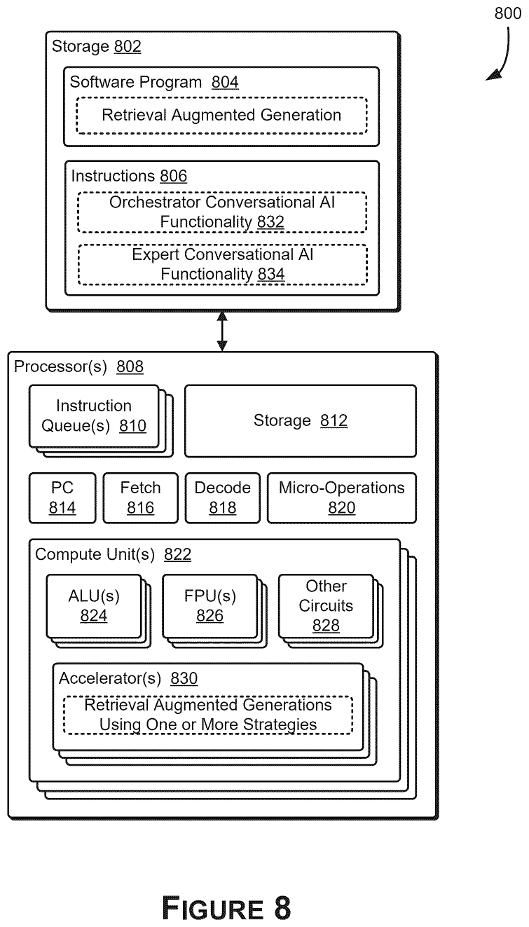

In at least one embodiment, the system 100 includes modules (e.g., as illustrated in FIG. 8) such that the system 100 performs one or more neural networks that implement conversational AIs to generate one or more responses to prompts (e.g., queries). In at least one embodiment, a module includes any combination of any type of logic (e.g., software, hardware, firmware) and/or circuitry configured to perform a function as described. In at least one embodiment, a module includes one or more circuits that form part of a larger system (e.g., an integrated circuit (IC), system on-chip (SoC), CPU, GPU, DPU, accelerator, etc.). In at least one embodiment, a controller includes any combination of any type of logic (e.g., software, hardware, firmware) and/or circuitry configured to perform a function as described. In at least one embodiment, software includes software packages, code, programming language, drivers, instructions, instruction sets, or some combination thereof. In at least one embodiment, hardware includes hardwired circuits, programmable circuits, state machine circuits, fixed function circuits, execution unit circuits, firmware with stored instructions executed by programmable circuits, or some combination thereof.

In at least one embodiment, the system 100 includes one or more logic units. In at least one embodiment, a logic unit includes firmware logic, hardware logic, or some combination thereof configured to provide any function as described further herein. In at least one embodiment, a logic unit includes circuitry that forms part of a larger system (e.g., IC, SoC, CPU, GPU, DPU). In at least one embodiment, a logic unit includes logic circuitry for implementation of firmware and/or hardware to perform conversational artificial intelligence (AI) to generate responses to queries.

In at least one embodiment, the system 100 includes one or more engines. In at least one embodiment, an engine includes a module and/or logic unit as described further herein. In at least one embodiment, a component includes a module and/or logic unit as described further herein. In at least one embodiment, an engine includes software logic, firmware logic, hardware logic, or some combination thereof configured to provide any function as described further herein. In at least one embodiment, a component includes software logic, firmware logic, hardware logic, or some combination thereof configured to provide any function as described further herein. In at least one embodiment, operations performed by hardware and/or firmware may alternatively be implemented via a software module, which may be embodied as a software package, code and/or instruction set. In at least one embodiment, a logic unit may also utilize a portion of software to implement its function.

The first expert computing system 104A, the second expert computing system 104B, and/or the third expert computing system 104C may each be a specialized with respect to an information domain and/or topic of information to be retrieved from one or more data stores. As an example, the first expert computing system 104A may implement a first expert that specializes in a particular domain, utilizing its RAG workflow to process queries and generate responses. Example data topics may include human resources, finance, general, logistics, news, technologies, and/or legal. By way of non-limiting examples, each of the expert computing system(s) 104 may include one or more processors 122 (e.g., GPU, PPU, CPU, DPU, and/or combinations thereof), a user interface 124, and/or memory 128. The processor(s) 122 may be implemented using one or more devices, such as any device(s) described herein, that is/are suitable for implementing the processor(s) 108. The user interface 124 may be implemented using one or more devices, such as any device(s) described herein, that is/are suitable for implementing the user interface 112. The memory 128 may be implemented using one or more devices, such as any device(s) described herein, that is/are suitable for implementing the memory 116. The processor(s) 122, the user interface 124, and/or the memory 128 may communicate with one another over one or more connections 126 that may be implemented using one or more connections, such as any connection(s) described herein, that is/are suitable for implementing the connection(s) 114.

The memory 128 (e.g., one or more non-transitory processor-readable medium) may store processor executable instructions 130 that when executed by the processor(s) 122 implement expert conversation AI functionality 132, and/or other functionality. The processor(s) 122 may include one or more circuits that perform at least a portion of the instructions 130 stored in the memory 128. As an example, the memory 128 stores data and/or instructions for receiving input from the orchestrator computing system(s) 102, performing the RAG process 106 based at least on the received input to generate results, and/or performing early termination (e.g., if the orchestrator has selected the inter-expert post-retrieval early termination strategy, the intra-expert post-retrieval early termination strategy, or a combination thereof).

As an example, each of the expert agents may perform the RAG process 106, which may include a query understanding process 106A, an information retrieval process 106B, an early termination process 106C, an access control process 106D (e.g., access control list (ACL) and/or enterprise content security (ECS)), a prompt engineering process 106E, an answer generation process 106F (e.g., using one or more LMs), and/or one or more other processes.

The query understanding process 106A may interpret and/or analyze input (e.g., user queries) to determine their intent and context, extracts information from the input (e.g., a query), and/or may generate one or more vector embeddings corresponding to the input. The input into the query understanding process 106A may include a prompt, such as a natural language query, which is processed to extract information and context. The output of the query understanding process 106A may include a refined query and/or a set of parameter values that guide the subsequent retrieval process 106B and/or the answer generation process 106F. In at least one embodiment, the query understanding process 106A performs input validation, such as to determine whether a question included in the input (e.g., prompt) is out of scope, beyond an expertise of the expert (e.g., a neural network), and/or otherwise improper.

The retrieval process 106B may access and/or gather relevant information from various data sources to generate results (e.g., a response to one or more user queries). The retrieval process 106B causes the processor(s) 122 to retrieve from one or more data sources accurate and contextually appropriate information based, at least in part, on the output of the query understanding process 106A, which is based at least on the expert input(s) received from the orchestrator agent (e.g., including a user input, prompt, and/or query). One or more inputs into the retrieval process 106B may include the refined query parameters generated by the query understanding process 106A, which the retrieval process 106B may use to access the appropriate data sources. Examples of data sources (e.g., data source(s) 410 illustrated in FIG. 4) may include internal databases, external databases, SharePoint sites, documents, external APIs, files, one or more data lake, and/or other data stores. The data accessed may include, for example, SEC filings and/or employee benefits information. In at least one embodiment, the retrieval process 106B is performed by one or more retrievers (e.g., retrievers 408 illustrated in FIG. 4). The retrieval process 106B outputs information, such as search results, a set of documents, data points, etc., that are used by the prompt engineering process 106E, and/or the answer generation process 106F, to formulate results that are responsive to the expert input(s) received from the orchestrator computing system(s) 102.

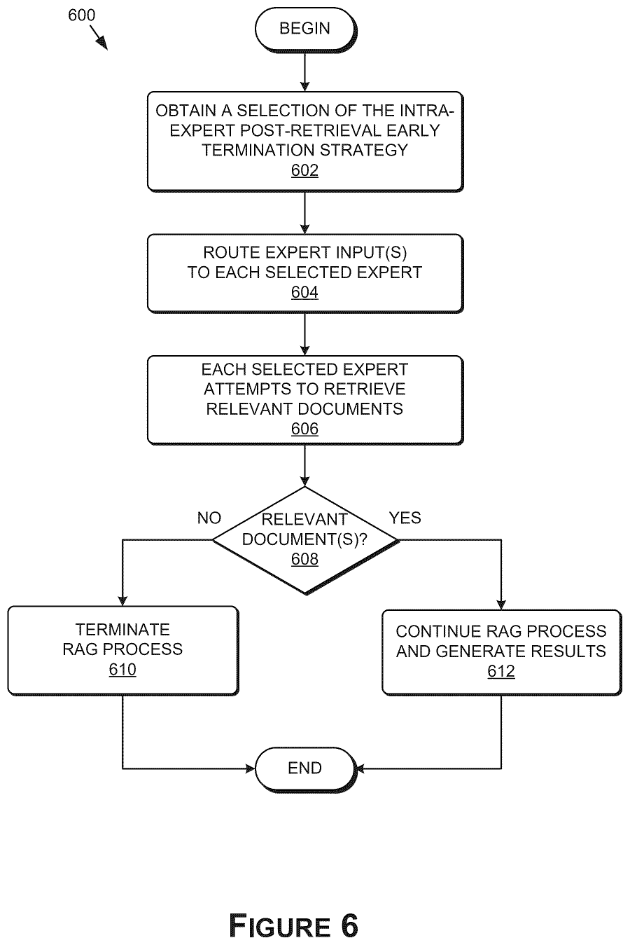

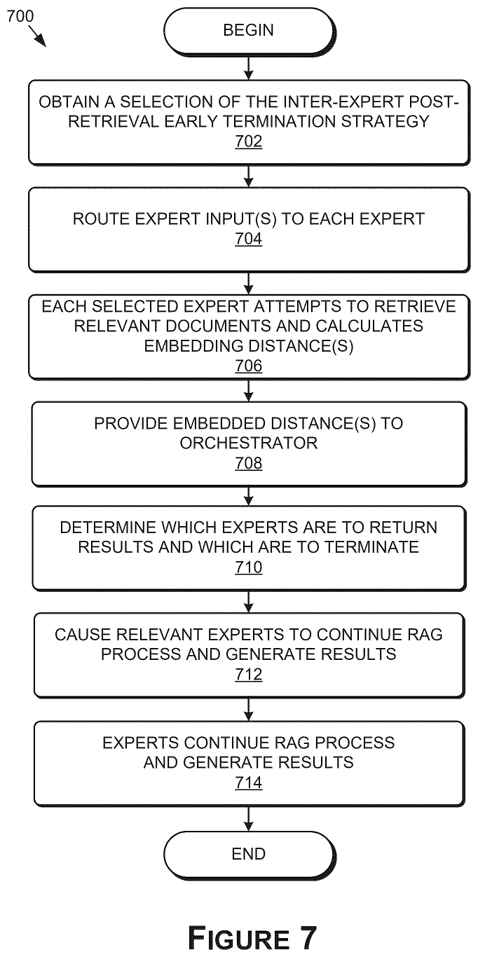

The early termination process 106C may decide whether to halt further processing of the expert input(s) received from the orchestrator computing system(s) 102 based, at least in part, on one or more criteria, such as whether the output of the retrieval process 106B includes information relevant to the expert input(s) received from the orchestrator computing system(s) 102 (a query). In at least one embodiment, the orchestrator computing system(s) 102 may cause the early termination process 106C to terminate processing the input received from the orchestrator computing system(s) 102 before results are generated by the expert. As an example, the early termination process 106C may be determined during performance of a method 500 (see FIG. 5A) by a method 600 (see FIG. 6), and/or a method 700 (see FIG. 7). The early termination process 106C may prevent unnecessary computations when the early termination process 106C determines that results returned by the expert are not be sufficiently relevant to the expert input(s) received from the orchestrator computing system(s) 102 (e.g., a query included in the expert input(s) cannot be effectively answered). The output of the retrieval process 106B may be input into the early termination process 106C. The early termination process 106C may assess relevance and/or quality of any information retrieved by the retrieval process 106B. The early termination process 106C may perform one or more operations to evaluate whether information retrieved by the retrieval process 106B is sufficient to proceed with generating a response, or if the RAG process 106 should be stopped. An output of the early termination process 106C may include a decision to either continue and perform the full or entire RAG process 106 and/or to terminate the RAG process 106 early to thereby conserve resources and/or improve efficiency.

The access control process 106D may filter the information output by the retrieval process 106B before the information is processed by the prompt engineering process 106E. The access control process 106D receives one or more inputs, such as the information output by the retrieval process 106B and/or output of the query understanding process 106A, which could include restricted information, sensitive information, confidential information, and/or one or more other types of information to which an owner of the information may wishes to limit or restrict access. The access control process 106D may help ensure that only authorized data is accessible and that confidential information is not disclosed. The output of the access control process 106D may be a filtered set of data that is deemed safe and appropriate for further processing, such as to be input into the prompt engineering process 106E, and/or the answer generation process 106F. The access control process 106D may help maintain security and integrity of the information accessed by the expert, for example, to comply with privacy and/or security standards. In at least one embodiment, the access control process 106D includes one or more information guard-railing operations and/or processes, such as to prevent confidential information from being retrieved by one or more end users, filtering information prior to processing by one or more neural networks (e.g., one or more LMs), and/or filters information retrieved before the information is accessed by the requestor(s) 103 (e.g., one or more users).

The prompt engineering process 106E may generate and/or refine one or more prompts to be provided to one or more neural networks (e.g., one or more LMs) of the answer generation process 106F. The prompt(s) generated by the prompt engineering process 106E may effectively interact with the LM(s) (e.g., one or more LLMs) of the answer generation process 106F and may cause the LM(s) to generate results. The prompt engineering process 106E may configure and/or adjust the prompt(s) such that the LM(s) understand(s) context and intent of the expert input(s) received from the orchestrator computing system(s) 102 (e.g., a query), such as to lead to accurate and/or relevant results. Input into the prompt engineering process 106E may include the output of the access control process 106D, which restricts the information used to generate the prompt to include only information remaining after having been filtered (e.g., appropriate content). The prompt engineering process 106E may implement techniques that rephrase queries or add contextual information to enhance the understanding of the LM. The output of the prompt engineering process 106E may be a well-structured prompt that is input into the LM of the answer generation process 106F, which may contribute to the quality and relevance of the results provided to the orchestrator agent.

The answer generation process 106F may use one or more LMs to produce results in response to the expert input(s) received from the orchestrator computing system(s) 102 (e.g., a user's query). The results may include a coherent and contextually relevant response to the expert input(s) received from the orchestrator computing system(s) 102. In at least one embodiment, an expert performing the RAG process 106 performs the answer generation process 106F using one or more LLMs to provide meaningful answers based on information retrieved by the retrieval process 106B (e.g., after filtering by the access control process 106D), and/or otherwise processed in earlier stages of the RAG process 106. One or more inputs into the answer generation process 106F may include the prompt(s) created by the prompt engineering process 106E, which are designed to cause the LM(s) of the answer generation process 106F to generate accurate responses and/or return information retrieved from data source(s) by the retrieval process 106B. The answer generation process 106F may include using one or more LLMs to synthesize input data (e.g., output by the retrieval process 106B) and produce a natural language response. The output of the answer generation process 106F may include complete and/or well-structured results that are provided to the orchestrator agent, which uses the results to generate output that is presented to the requestor(s) 103 (e.g. a user). The output of the orchestrator agent may include or be accompanied by one or more citations and/or references to the sources of the information used in crafting the output of the orchestrator agent.

The orchestrator conversational AI functionality 120 (e.g., performed by the processor(s) 108) may use the expert agents (e.g., implemented by the expert computing system(s) 104) to obtain output to provide to the requestor(s) 103, for example, operating or implemented by the client computing device(s) 105. The client computing device(s) 105 may be implemented using one or more cellular telephones, one or more laptop computers, one or more personal computers, one or more tablets, one or more servers, and/or one or more other user devices. The client computing device 105 may be implemented using any components suitable for implementing the orchestrator computing system(s) 102. For example, the client computing device(s) 105 may include processor(s), a user interface, and memory. The processor(s) of the client computing device(s) 105 may be implemented using one or more devices, such as any device(s) described herein as being suitable for implementing the processor(s) 108. The user interface of the client computing device(s) 105 may be implemented using one or more devices, such as any device(s) described herein as being suitable for implementing the user interface 112. The memory of the client computing device(s) 105 may be implemented using one or more devices, such as any device(s) described herein as being suitable for implementing the memory 116. The processor(s), the user interface, and/or the memory of the client computing device(s) may communicate with one another over one or more connections that may be implemented using any connection(s), such as any of the connection(s) described herein as being suitable for implementing the connection(s) 114.

The orchestrator computing system(s) 102, the expert computing system(s) 104, and/or the client computing device(s) 105 may communicate with one another over a network 134. The network 134 may be implemented using a local area network (LAN), a Wide Area Network (WAN), an internal network within a data center, the Internet, a Storage Area Network (SAN), a Data Center Interconnect (DCI), a Virtual Local Area Network (VLAN), a Cloud Network, a High-Performance Computing (HPC) Network, a Converged Network, and/or one or more other types of networks. In at least one embodiment, at least a portion of the network 134 is implemented using at least a portion of any system(s) depicted in and/or described with respect to FIGS. 9A-11. In at least one embodiment, at least a portion of the network 134 is used to implement at least a portion of any system(s) depicted in and/or described with respect to FIGS. 9A-11.

In at least one embodiment, the system 100 includes one or more processors to receive, by an orchestrator conversational AI (e.g., chat bot), one or more inputs; use, by the orchestrator conversational AI, one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, the system 100 is included in, and/or otherwise includes systems illustrated in any of FIGS. 1-8 and/or described with respect to any of FIGS. 1-8, to receive, by an orchestrator conversational AI, one or more inputs; use, by the orchestrator conversational AI, one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, the system 100 performs one or more processes illustrated in any of FIGS. 1-8 and/or described with respect to any of FIGS. 1-8, such as to receive, by an orchestrator conversational AI, one or more inputs; use, by the orchestrator conversational AI, one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, the system 100 includes one or more hardware illustrated in FIGS. 9A-11, such as to receive, by an orchestrator conversational AI, one or more inputs; use, by the orchestrator conversational AI, one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein.

With reference to FIG. 2, FIG. 2 is a block diagram 200 illustrating an example orchestrator agent 204 using one or more strategies to determine a set 212 of a plurality of expert agents 214 to provide results in response to one or more inputs 201, in accordance with some embodiments of the present disclosure. The orchestrator agent 204 may be implemented at least in part by the orchestrator computing system(s) 102 (see FIG. 1). For example, the orchestrator conversational AI functionality 120 (e.g., performed by the processor(s) 108) may implement the orchestrator agent 204. The plurality of expert agents 214 may be implemented at least in part by the orchestrator computing system(s) 102 and/or the expert computing system(s) 104. For example, the expert conversational AI functionality 132 (e.g., performed by the processor(s) 122) may implement the plurality of expert agents 214. The client computing device 105 may provide the input(s) 201 to the orchestrator agent 204 via an interface 202. The requestor(s) 103 may use the client computing device 105 and/or the user interface 112 to provide the input(s) 201 to the orchestrator agent 204 via the interface 202. The interface 202 may be implemented at least in part by the orchestrator conversational AI functionality 120 (e.g., performed by the processor(s) 108).

The requestor(s) 103 may provide (e.g., via the interface 202) the input(s) 201 (e.g., one or more prompts including one or more questions or queries) to the orchestrator agent 204 to solicit a response (e.g., output 216) from the orchestrator agent 204. The input(s) 201 may have any format. For example, the input(s) 201 may be text written in natural language, a structured query (e.g., written in structured query language (SQL)), computer code, scripts, macros, audio data, image data, video data, symbolic data, and/or others.

The input(s) 201 may include text data having a format, such as Plain Text (TXT), Rich Text Format (RTF), Hypertext Markup Language (HTML), Extensible Markup Language (XML), JavaScript Object Notation (JSON), Comma-Separated Values (CSV), Markdown (MD), LaTeX (TEX), Portable Document Format (PDF), Microsoft Word Document (DOCX), ASCII, Portable Document Format (PDF), and/or others. The input(s) 201 may include audio data having a format, such as MPEG-1 Audio Layer III (MP3), Waveform Audio File Format (WAV), Advanced Audio Codec (AAC), Free Lossless Audio Codec (FLAC), Windows Media Audio (WMA), Ogg Vorbis (OGG), Apple Lossless Audio Codec (ALAC), Audio Interchange File Format (AIFF), Adaptive Multi-Rate (AMR), Opus, and/or others. The input(s) 201 may include image data having a format, such as Joint Photographic Experts Group (JPEG) format, Portable Network Graphics (PNG) format, Graphics Interchange Format (GIF), Bitmap (BMP) format, Tagged Image File Format (TIFF), Scalable Vector Graphics (SVG) format, Web Picture (WEBP) format, High Efficiency Image File Format (HEIF), Raw Image Format (RAW), Photoshop Document (PSD) format, PDF, and/or others. The input(s) 201 may include video data having a format, such as MPEG-4 Part 14 (MP4), Audio Video Interleave (AVI), QuickTime File Format (MOV), Windows Media Video (WMV), Flash Video Format (FLV), Matroska Video Format (MKV), Web Media (WEBM), Moving Picture Experts Group (MPEG), 3rd Generation Partnership Project (3GP), Advanced Video Coding High Definition (AVCHD), High Efficiency Video Coding (HEVC or H.265), Ogg Video (OGV), MPEG Transport Stream (MTS/M2TS), and/or others. In some embodiments, the input(s) 201 may include design data (e.g., computer aided design data, 2D design data, 3D design data, and/or other types of design data), universal scene descriptor data (USD)—such as OpenUSD data—such as for Metaverse or NVIDIA's OMNIVERSE applications—or other 3D content generation and orchestration systems, and/or other types of data.

The set 212 of expert agents illustrated includes at least three expert agents 206-1, 206-2, and 206-3. However, the set 212 of expert agents may include any number of expert agents including a single expert agent or all of the plurality of expert agents 214. The plurality of expert agents 214 has been illustrated as including expert agents 106-1 to 106-N but may include any number of expert agents.

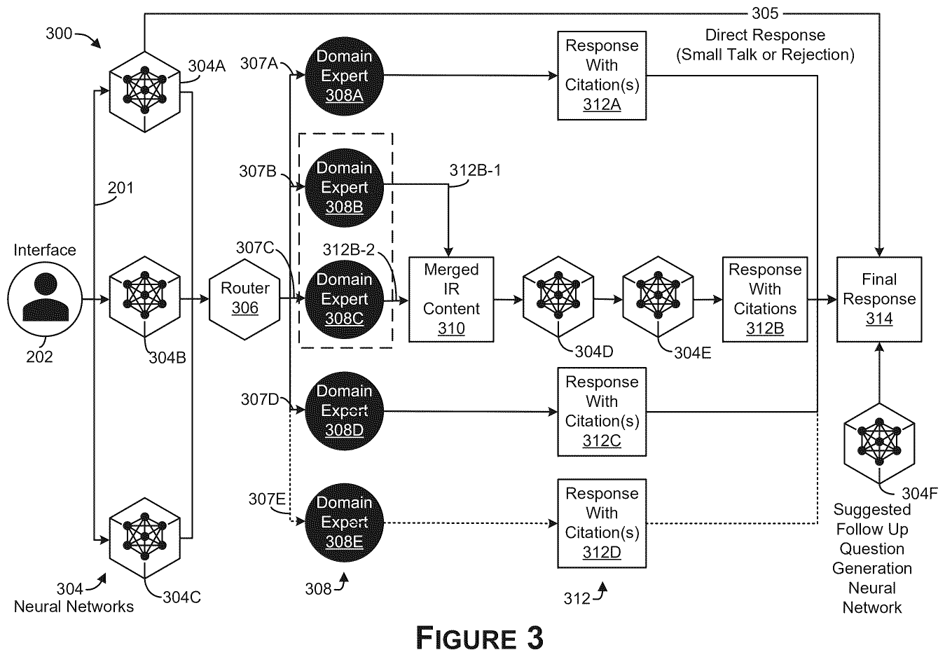

The system 100 (see FIG. 1) may utilize a “mixture of experts” approach, in which the orchestrator agent 204 coordinates the set 212 of expert agents (e.g., the expert agents 206-1 to 206-3), each potentially focusing on and/or having access to information related to a specific domain or topic. The orchestrator agent 204 may employ various strategies, such as the post-facto expert selection strategy, the pre-facto expert selection strategy, the inter-expert post-retrieval early termination strategy, the intra-expert post-retrieval early termination strategy, and/or combinations thereof to retrieve information from the set 212 of expert agents. This modular design may be scalable and/or flexible, enabling the integration of additional expert agents as needed. As mentioned herein, the system 100 (see FIG. 1) may include the expert computing system(s) 104 (see FIG. 1) and/or otherwise implement the expert agents 214, each with its own RAG workflow. The expert agents 214 (e.g., the expert agents 206-1 to 206-N) may operate independently, leveraging their unique expertise and retrieval capabilities to contribute to the overall functionality of the orchestrator agent 204. Two or more of the expert agents 214 may operate in combination to generate results (e.g., domain experts 308B and 308C, illustrated in FIG. 3). The orchestrator agent 204 (e.g., implemented by the orchestrator computing system(s) 102) may perform operations which include natural language understanding, query interpretation, and response generation. The orchestrator agent 204 may generate responses (e.g., output 216) to the requestor(s) 103 (e.g., users) in a conversational manner, accurately interpreting the input(s) 201 (e.g., user queries), and synthesizing information into coherent and/or contextually relevant responses. The orchestrator agent 204 might also have the ability to pre-examine retrieved content retrieved by each of the expert agents 214, and decide which of the expert agents 214 should proceed with performing the full RAG process 106 (e.g., using the method 600 and/or the method 700), and which, if any of the expert agents 214, are to stop after performing information retrieval (e.g., after the retrieval process 106B and before the prompt engineering process 106-E). The network 134 may facilitate communication and data exchange between the orchestrator computer system(s) 102, the expert computer system(s) 104, and/or the client computing device(s) 105, while the user interface 112 might provide a platform for the requestor(s) 103 (e.g., users) to use to provide the input(s) 201 (e.g., queries) to and receive responses from the orchestrator agent 204. Overall, this architecture may offer a robust and efficient solution for meeting diverse information needs of an entity or organization.

The orchestrator agent 204 may perform one or more tasks or processes, such as a chat history and personal context management process 204A, a question understanding and validation process 204B, a question routing process 204C, an answer collection process 204D, a final answer generation process 204E (e.g., using a LM), a final guard-railing process 204F, and/or combinations thereof. The orchestrator agent 204 performs the processes 204A-204F at least in part by using the input(s) 201 to identity the set 212 of expert agents, using the input(s) 201 and/or information related to the set 212 of expert agents to identity the one or more strategies, routing a set 208 of expert inputs (e.g., one or more questions) to the selected set 212 of expert agents in accordance with the selected strategy(ies), receiving a set 210 of results from the set 212 of expert agents, and using the set 210 of results to generate the output 216. The orchestrator agent 204 may provide the output 216 to the requestor(s) 103 via the interface 202. The orchestrator agent 204 may ensure that user queries are directed to the most relevant expert agents, facilitating efficient and accurate response generation.

The chat history and personal context management process 204A may receive one or more inputs 205A from one or more operations, such as input(s) provided to the orchestrator agent 204 during previous use of the orchestrator agent 204 by the requestor(s) 103. The chat history and personal context management process 204A may record one or more previous interactions with the orchestrator agent 204 (e.g., previous input, such as queries, and/or generated responses). The chat history and personal context management process 204A may generate output 205B by aggregating and/or summarizing information (e.g., the input(s) 205A) related to previous use of the orchestrator agent 204. The chat history and personal context management process 204A may be implemented using one or more neural networks, such as LMs.

The output 205B of the chat history and personal context management process 204A may be provided to the question understanding and validation process 204B, which may use the output 205B to understand the input(s) 201 and/or to validate the input(s) 201. The question understanding and validation process 204B may classify the input(s) 201 (e.g., using the output 205B) as valid or invalid. If the question and understanding validation process 204B classifies the input(s) 201 as valid, the question and understanding validation process 204B generates output 205C, which may include the input(s) 201 and/or information based at least on the input(s) 201, such as one or more embeddings of the input(s) 201. On the other hand, if the question and understanding validation process 204B classifies that the input(s) 201 as invalid, the process 204B may provide an indication to the requestor(s) 103 (e.g., via the interface 202) that the input(s) 201 are invalid and/or rejected. The question and understanding validation process 204B may be implemented using one or more neural networks, such as LMs.

The output 205C is received by the question routing process 204C, which may use the output 205C to determine which of the plurality of expert agents 214 to include in the set 212, which strategy(ies) to use, and/or what to include in the set 208 of expert inputs. As an example, the question routing process 204C may use the output 205C to determine a scope of a question included in the input(s) 201, which may be relevant to one or more of the plurality of expert agents 214. By way of a non-limiting example, the question routing process 204C may classify the query as being relevant to one or more specific topics, and decide to route the query to one or more of the plurality of expert agents 214 also classified and/or identified as being associated with the topic(s). The question routing process 204C may include descriptions of the expert agents 214 that identify a scope of expertise of each of the expert agents 214, and/or associate each of the expert agents 214 with one or more particular topics (e.g., as being able to retrieve information related to the particular topic(s)). The question routing process 204C may use the descriptions to identify any of the expert agents 214 for inclusion in the set 212 that is/are associated with the same topic(s) as the input(s) 201. Non-limiting examples of topics include human resources, finance, general, logistics, news, technologies, or legal.

The question routing process 204C may tailor at least a portion of the set 208 of expert inputs for one or more of the expert agents in the set 212. For example, the question routing process 204C may rephrase the input(s) 201 to include terminology more likely to be present in the data retrievable by a particular one of the set 212 of expert agents. By way of another non-limiting example, if the input(s) 201 include a question classified by the question routing process 204C as being related to first and second topics, and a particular one of the set 212 of expert agents (e.g., the expert agents 206-1) is relevant to only the first topic, the question routing process 204C may generate an expert input (e.g., the expert input 208-1) to the particular expert agent that requests results related only to the first topic. The question routing process 204C may include an indication in the set 208 of expert inputs indicating which strategy one or more of the set 212 of expert agents are to use. For example, the set 208 of expert inputs may indicate whether a particular expert agent in the set 212 of expert agents is to perform the early termination process 106C (see FIG. 1). The question routing process 204C may direct the set 208 of expert inputs (e.g., based on user queries included in the input(s) 201) to the set 212 of relevant expert agents. The question routing process 204C may be implemented using one or more neural networks, such as LMs.

Any of the expert agents in the set 212 of expert agents that performs the full RAG process 106 (e.g., does not terminate early) may generate results (included in the set 210 of results) in response to at least one corresponding expert input (included in the set 208 of expert inputs). In the example illustrated in FIG. 2, the expert agents 206-1, 206-2, and 206-3 generate outputs 210-1, 210-2, and 210-3, respectively, in response to expert inputs 208-1, 208-2, and 208-3, respectively. However, in some embodiments, one or more of the expert agents in the set 212 may terminate early and not produce results. Those of the set 212 of expert agents that generated results, transmit the results to the orchestrator agent 204.

The orchestrator agent 204 may perform the answer collection process 204D to evaluate the set 210 of results to determine whether the set 210 of results is responsive to the input(s) 201. If the answer collection process 204D determines the set 210 of results are not responsive to the input(s) 201, the answer collection process 204D may notify the requestor(s) 103 (e.g., via the interface 202) and/or cause the question routing process 204° C. to formulate one or more new expert inputs for one or more of the plurality of expert agents 214 seeking additional results. On the other hand, if the answer collection process 204D determines the set 210 of results are responsive to the input(s) 201, the answer collection process 204D may generate output 205D, which may include the set 210 of results, an aggregation of the set 210 of results, a summary of the set 210 of results, and/or may otherwise be based at least in part on the set 210 of results. The answer collection process 204D may implement different flow patterns with respect to the set 212 of expert agents. For example, the answer collection process 204D may provide the output of one expert agent as input to another expert agent. By way of another non-limiting example, the answer collection process 204D may aggregate (e.g., concatenate, average, total, etc.) the results output by subset of the expert agents in the set 212 to obtain combined results for the subset. The answer collection process 204D may forward the output 205D to the final answer generation process 204E. The answer collection process 204D may be implemented using one or more neural networks, such as LMs.

The final answer generation process 204E may generate output 205E (e.g., an answer to a question included in the input(s) 201) by synthesizing the output 205D of the answer collection process 204D. The final answer generation process 204E may be implemented using one or more neural networks, such as LM(s). The final answer generation process 204E may use one or more advanced AI techniques to generate the output 205E that is responsive to the input(s) 201 received from the requestor(s) 103. The final answer generation process 204E may be implemented using one or more LMs (e.g., LLM(s), SLM(s), VLM(s), MMLM(s), etc.), which may generate nuanced and/or contextually appropriate output based at least in part on the output 205D of the answer collection process 204D (e.g., the set 210 of results or information based at least in part on the set 210 of results). The orchestrator agent 204 may then provide the output 105E of the final answer generation process 204E to the final guard-railing process 204F.

The final guard-railing process 204F may serve as a quality control measure, such as to ensure that a generated response (e.g., the output 216) adheres to predefined guidelines and/or standards. As an example, the final guard-railing process 204F may filter irrelevant content, which may provide an additional layer of assurance that the orchestrator agent 204 delivers accurate and/or reliable information to the requestor(s) 103. The final guard-railing process 204F outputs the output 216 of the orchestrator agent 204. The output 216 (e.g., an answer) generated by the orchestrator agent 204, using one or more of the set 212 of expert agents and/or one or more processes illustrated in FIGS. 5A-7, is returned to the requestor(s) 103 (e.g., via the interface 202). The final guard-railing process 204F may be implemented using one or more neural networks, such as LMs.

The orchestrator agent 204 may be characterized as using a mixture of experts architecture, in which the orchestrator agent 204 is connected to multiple expert agents (e.g., the plurality of expert agents 214), each potentially a standalone conversational AI focusing on a specific domain of knowledge or expertise. The orchestrator agent 204 may select one or more of the expert agents to contribute results in response to the input(s) 201 (e.g., one or more input questions), and formulate the output 216 (e.g., select or ensemble answers) using the set 210 of results received from one or more of the expert agents. Each of one or more of the expert agents may perform processing with respect to a corresponding one of the set 208 of expert inputs, which may include understanding the corresponding input, using the corresponding input to retrieve information, reranking, guard-railing, and/or generating results based at least in part on the retrieved information. This architecture may offer scalability for integrating new domains and/or flexibility because each expert's contribution is separate from contributions made by other expert agents. The mixture of experts architecture may broaden the knowledgebase accessible by the orchestrator agent 204 while allowing new experts to be integrated to extend that knowledgebase.

Further, the mixture of experts architecture allows one or more expert agents to be modified and/or replaced without impacting other expert agents. For example, one or more expert agents may improve independently without impacting other expert agents and/or their knowledge domains. Additionally, each expert may adopt its own customized procedures, for example, for query processing, information retrieval, and/or answer generation, without compromising the abilities of other expert agents. The orchestrator agent 204 may leverage the domain knowledge of one or more of the plurality of expert agents 214 to produce the output 216, which may be a final ensemble answer. In at least one embodiment, an orchestrator conversational AI (e.g., the orchestrator agent 204) receives one or more inputs (e.g., the input(s) 201), uses one or more strategies to determine one or more expert conversational AIs (e.g., the set 212 of expert agents) to provide one or more responses (e.g., the set 210 of results) to the one or more inputs, and determines at least one answer (e.g., the output 216) to the one or more user inputs based at least on a portion of the one or more responses and/or otherwise perform operations described herein.

With reference to FIG. 3, FIG. 3 is a block diagram illustrating an example system 300 to implement the orchestrator agent 204 (see FIG. 2), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 9A-9C), one or more computing devices or components thereof (e.g., as described in FIG. 10), and/or one or more data centers or components thereof (e.g., as described in FIG. 11).

In at least one embodiment, the system 300 includes one or more interfaces (e.g., the interface 202), one or more neural networks (NN(s)) 304 (e.g., guard-railing NN(s) 304A, chat history and/or query contextualization NN(s) 304B, pre-facto expert selection NN(s) 304C, embedding reranker NN(s) 304D, answer summarization NN(s) 304E, and/or suggested follow-up question generation NN(s) 304F), a task planner and/or router 306, one or more domain experts 308 (e.g., domain experts 308A-E), a merge process to generate merged information retrieval (IR) content 310, and/or an aggregation process to generate final response(s) 314. The system 300 may include a “mixture of experts” architecture, potentially using one or more of the domain expert(s) 308, each possibly owning its own RAG pipeline, to provide results with respect to specific topics and/or use cases.

The requestor(s) 103 (e.g., a user, user equipment, and/or a device) may use the interface(s) (e.g., the interface 202) to provide the input(s) 201 to the system 300. The input(s) 201 may be routed to the guard-railing NN(s) 304A, the chat history and/or query contextualization NN(s) 304B, and/or the pre-facto expert selection NN(s) 304C. The guard-railing NN(s) 304A may serve as a protective mechanism within the system 300, such as to ensure that the input(s) 201 (e.g., user queries) and one or more responses (e.g., direct response(s) 305, final response(s) 314, and/or the like) adhere to predefined guidelines and/or restrictions. The guard-railing NN(s) 304A may receive contextual information from the chat history, which the guard-railing NN(s) 304A may use to assess whether the input(s) 201 is/are appropriate and/or fall(s) within permissible scope. For example, the guard-railing NN(s) 304A may be a component of and/or used by the question understanding and validation process 204B (see FIG. 2), which may receive chat history and/or other information from the chat history and personal context management process 204A (see FIG. 2). The question understanding and validation process 204B may use the guard-railing NN(s) 304A to determine whether the input(s) 201 are valid. The guard-railing NN(s) 304A may evaluate and potentially filter out one or more of the input(s) 201 and/or one or more responses (e.g., one or more of the direct response(s) 305, one or more of the final response(s) 314, and/or the like) that contain sensitive and/or restricted information. As an output, the guard-railing NN(s) 304A may generate a decision with respect to whether to proceed with processing the input(s) 201 (e.g., the guard-railing NN(s) 304A has classified the input(s) 201 as being valid) or to terminate the interaction early, thereby maintaining compliance and security within the system (e.g., the guard-railing NN(s) 304A has classified the input(s) 201 as being invalid).

The system 300 may first determine if the input(s) 201 (e.g., a query) is/are proper (e.g., valid) and/or needs context associated therewith, such as by using the chat history and query contextualization NN(s) 304B. For example, the chat history and query contextualization NN(s) 304B may be a component of and/or used by the chat history and personal context management process 204A (see FIG. 2). The chat history and query contextualization NN(s) 304B may perform one or more operations to understand and/or contextualize the input(s) 201 by analyzing the chat history, which may include previous interactions and/or relevant context. Input(s) into the chat history and query contextualization NN(s) 304B may include any related historical data from past interactions. The chat history and query contextualization NN(s) 304B may provide a contextualized understanding of the input(s) 201 (e.g., query), which may be used to route input to appropriate ones of the domain experts 308. One or more outputs from the chat history and query contextualization NN(s) 304B may include a refined query or a set of contextual parameters that may help guide the orchestrator agent 204 in selecting the most relevant ones of the domain experts 308 to generate results.

In some embodiments, the system 300 may perform a pre-facto expert selection strategy, such as by using the pre-facto expert selection NN(s) 304C. In at least one embodiment, the pre-facto expert selection NN(s) 304C performs at least a portion of the method 520 (see FIG. 5B). The pre-facto expert selection NN(s) 304C may select one or more appropriate ones of the domain experts 308 to which to route input(s) to obtain results. The pre-facto expert selection NN(s) 304C may receive one or more inputs, such as the input(s) 201, information based at least in part on the input(s) 201, and/or any contextual information derived from the chat history (e.g., generated by the chat history and query contextualization NN(s) 304B). The pre-facto expert selection NN(s) 304C may analyze these input(s) and determine which of the domain experts 308 are likely to provide relevant results (e.g., information and/or answers). The pre-facto expert selection NN(s) 304C may select the domain experts based at least on a comparison of the input(s) 201 to the scope or domain of each of the domain experts 308 (e.g., included in descriptions of the domain experts 308). As an output, the pre-facto expert selection NN(s) 304C may generate a list of one or more selected domain experts and/or a routing plan that guides the orchestrator agent 204 in directing input(s) (e.g., the query) to the selected domain experts.

The task planner and/or router 306 may manage the flow of tasks and queries through the system 300 architecture. The task planner and/or router 306 may receive one or more inputs, such as the input(s) 201 filtered by the guard-railing NN(s) 304A, and/or one or more inputs generated by the chat history and query contextualization NN(s) 304B (e.g., contextual information, input(s) based at least in part on the input(s) 201, etc.), which may have been filtered by the guard-railing NN(s) 304A. The task planner and/or router 306 may determine a path or data flow to be used to process the input(s) 201, using one or more of the domain experts 308. The task planner and/or router 306 may utilize a directed acyclic graph (DAG) structure to efficiently coordinate the execution of one or more tasks, such as to ensure each step is logically sequenced and dependencies are respected. One or more outputs from the task planner and/or router 306 may include a structured plan or route that guides the orchestrator agent 204 in engaging appropriate ones of the domain experts 308, ultimately leading to the generation of a coherent and accurate response for the requestor(s) 103.

In FIG. 3, for illustrative purposes, the domain experts 308 are illustrated as including domain experts 308A-308E. However, the domain experts 308 may include a different number of domain experts than is illustrated. As an example, the domain expert 308A may receive input(s) 307A, retrieve financial information from one or more data sources, and generate a response with citation(s) 312A. The domain expert 308B may receive input(s) 307B, retrieve help information from one or more data sources, and generate a response 312B-1, and the domain expert 308C may may receive input(s) 307C, retrieve Sharepoint information from one or more data sources, and generate a response 312B-2. Subsequently, a merge process (e.g., concatenation) may merge the responses 312B-1 and 312B-2 into the merged IR content 310, in which, for example, retrieved content of a help expert and Sharepoint expert are merged. While the domain experts 308B and 308C have been illustrated as generating the responses 312B-1 and 312B-2 in parallel, the domain experts 308B and 308C may instead generate the responses 312B-1 and 312B-2 in series. For example, the orchestrator agent 204 may input the response 312B-1 generated by the domain expert 308B, as the input(s) 307C, into the domain expert 308C, which may output the merged IR content 310 (e.g., as the response 312B-2). Such embodiments may omit the separate merge process. In at least one embodiment, the orchestrator agent 204 performs at least a portion of the answer collection process 204D, which may include the merge process used to merge the responses 312B-1 and 312B-2, and/or may cause one or more of the experts to generate results serially and/or in parallel.

The merged IR content 310 may be received by the embedding reranker NN(s) 304D, such as to rank the merged IR content 310 and/or generate one or more embeddings. The merged IR content 310 with one or more embeddings generated by the embedding reranker NN(s) 304D is received by the answer summarization NN(s) 304E (e.g., one or more LMs) to generate one or more answers with citation(s) 312B. As an example, the domain expert 308D may receive input(s) 307D, retrieve scheduling information (e.g., holidays) from one or more data sources, and generate a response with citation(s) 312C. By way of another non-limiting example, the domain expert 308E may receive input(s) 307E, retrieve people-related information from one or more data sources, and generate a response with citation(s) 312D. The orchestrator agent 204 uses the responses with citation(s) 312A-312D to generate the final response(s) 314 (e.g., the output 216). For example, the orchestrator agent 204 may use the final answer generation process 204E to generate the final response 314.

The suggested follow-up question generation NN(s) 304F may generate one or more suggested follow-up questions based, at least in part, on the input(s) 201, the responses with citation(s) 312A-312D, the output 216, and/or history of user queries (e.g., provided by the chat history and/or query contextualization NN(s) 304B). The orchestrator agent 204 may use the interface 202 to provide the suggested follow up question(s) to the requestor(s) 103 and/or to cause a display device of the client computing device 105 to display the suggested follow up question(s). In at least one embodiment, the orchestrator agent 204 may generate an intermediate response and/or the output 216 using one or more subsets of responses obtained from the domain experts 308.

In at least one embodiment, the system 300 includes one or more processors to receive, by an orchestrator conversational AI (e.g., chat bot), one or more inputs; use, by the orchestrator conversational AI, one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, the system 300 is included in, and/or otherwise includes systems illustrated in any of FIGS. 1-8 and/or described with respect to any of FIGS. 1-8, to receive, by an orchestrator conversational AI, one or more inputs; use, by the orchestrator conversational AI, one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, the system 300 performs one or more processes illustrated in any of FIGS. 1-8 and/or described with respect to any of FIGS. 1-8, such as to receive, by an orchestrator conversational AI, one or more inputs; use, by the orchestrator conversational AI, one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, the system 300 includes one or more hardware illustrated in FIGS. 9A-11, such as to receive, by an orchestrator conversational AI, one or more inputs; use, by the orchestrator conversational AI, one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein.

By way of non-limiting examples, the system 300 may leverage one or more of the following strategies to reduce (e.g., minimize) latency: optimize topology of a graph to identify one or more nodes with no inter-dependencies for parallel execution; cache intermediaries in a pipeline with respect to user context and query context; utilize one or more smaller LMs to respond faster for simpler asks; and/or optimize one or more of the retrievers 408 (see FIG. 4) to reduce search overhead and avoid extra re-ranking steps.

With reference to FIG. 4, FIG. 4 is a block diagram illustrating an example system 400 that implements an orchestrator 404 that uses experts 406 to perform information retrieval, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 9A-9C), one or more computing devices or components thereof (e.g., as described in FIG. 10), and/or one or more data centers or components thereof (e.g., as described in FIG. 11).

The experts 406 (e.g., the expert agents 406-1 to 406-K) may be referred to as expert agents (e.g., the expert agents 214 illustrated in FIG. 2) and/or domain experts (e.g., the domain experts 308 illustrated in FIG. 3). One or more of the experts 406 may include one or more neural networks to determine which information is to be retrieved from one or more data sources, such as data sources related to a particular information domain (e.g., topic and/or scope of information). As an example, one or more domains may be included in one or more topics, and information related to one or more topics may be included in one or more domains. As an example, if a new topic is identified that is largely unrelated to existing topics, a new expert may be implemented and added to the experts 406. This new expert might be supported by its own information retrieval performed with respect to one or more data sources storing data related to the new topic, along with one of the retrievers 408, its own prompt engineering tailored to that new topic, and any other components for specific use cases. The system 400 can remove a particular topic (e.g., if the topic or support for the expert is discontinued), by removing any experts (e.g., the expert 406-2) related to that particular topic from the experts 406 (e.g., from a graph representing the experts 406) without affecting other experts.

Each of the experts 406 may include a retriever and data source(s) from which the retriever retrieves information. For example, the experts 406-1 to 406-K include retrievers 408-1 to 408-K, respectively. The retrievers 408-1 to 408-K extract information from data source(s) 410-1 to 410-K, respectively.

Retrievers 408 (e.g., the retrievers 408-1 to 408-K) perform backend operations of the RAG process 106, obtaining information from the data source(s) 410. By way of non-limiting examples, the system 400 may implement one or more of the retrievers 408 using Glean and/or NeMo. The retrievers 408 may be utilized for data ingestion, search, ranking, and/or passage retrieval. One or more of the experts 406 may use only one of the retrievers 408 to avoid complexity in post-processing related to ranking results obtained by multiple retrievers.

The orchestrator 404 may include one or more neural networks that generate one or more answers 412 (e.g., the output 216 illustrated in FIG. 2) by combining results obtained from one or more other neural networks that each perform a RAG process (e.g., the RAG process 106 illustrated in FIG. 1). The orchestrator 404 may implement one or more of the strategies described herein to retrieve information from the data source(s) 410 that the orchestrator 404 uses to generate the answer(s) 412, which may be a conversational or natural language response to a query (e.g., included in the input(s) 201). These strategies may include the post-facto expert selection strategy, the pre-facto expert selection strategy, and a post-retrieval early termination strategy (e.g., the intra-expert post-retrieval early termination strategy, the inter-expert post-retrieval early termination strategy, or combinations thereof). The system 400 might utilize one or more of these strategies to optimize the retrieval process and/or to ensure efficient and/or accurate responses.

Using the post-facto expert selection strategy, the orchestrator 404 may request that all of the experts 406 generate results in response to the input(s) 402 (e.g., a question). Then, the orchestrator 404 may perform answer selection and/or aggregation before delivering the answer(s) 412 (e.g., to the interface 202). The orchestrator 404 and/or the experts 406 may use one or more LMs, (e.g., LLM(s), SLM(s), VLM(s), MMLM(s), etc.).

Using the pre-facto expert selection strategy, the orchestrator 404 may perform content understanding with respect to the input(s) 402, and/or classify each the input(s) 402 (e.g., using multiple classes, and/or multiple labels) into one or more classes that each correspond to one or more of the experts 406. The pre-facto expert selection strategy may be more effective when subject matter to which the input(s) 402 relates is/are clear and/or readily determinable. For instance, the subject matter of a prompt like “Company's financial results 2023” might be readily determinable to be company financial information, and the orchestrator 404 may route such a prompt to an expert with appropriate domain knowledge (e.g., to a chatbot with access to company financial information) because such an expert is identified as being relevant to (e.g., includes a classification related to) that subject matter. If only one expert is associated with (e.g., includes a classification related to) the subject matter of the input(s) 402, only that expert will be selected by the orchestrator 404 using the pre-facto expert selection strategy. In scenarios in which the input(s) 402 relate to content accessible by more than one expert (e.g., multiple chatbots), the orchestrator 404 might invoke multiple experts. The number of experts involved may be proportional to a scope or ambiguity of the input(s) 402 (e.g., question(s)). In at least one embodiment, the input(s) 402 may be classified according to data type, data topic, an answer quality indicator, a computational resource consumption indicator, and/or a latency indicator.

Using the post-retrieval early termination strategy, the orchestrator 404 may instruct each of the experts 406 performing its own RAG workflow (e.g., performing the RAG process 106), which may include using one of the retrievers 208 to retrieve information before generating one or more prompts to provide to one or more LMs (e.g., e.g., LLM(s), SLM(s), VLM(s), MMLM(s), etc.), to perform or cause to be performed an evaluation of the information retrieved, and if that information is not sufficiently relevant to the input(s) 402 to skip generating the prompt(s). Because the LM(s) generate(s) the results based at least in part on the retrieved information, when prompt generation is skipped, the expert will not return a result. For example, the orchestrator 404 may cause one or more of the experts 406 to determine whether retrieved content qualifies for invoking the LM(s) (e.g., whether the content satisfies one or more criteria).

The post-retrieval early termination strategy may implement intra-expert termination and/or inter-expert termination. Intra-expert termination is performed separately by each of the experts 406, which may each calculate a per-RAG embedding distance between the retrieved information (e.g., one or more documents) and the input(s) received by the expert, and compare the per-RAG embedding distance to a predetermined threshold value. For example, a particular one of the experts 406 may calculate a per-item embedding distance between each separate item of the retrieved information (e.g., a document) and each of the input(s) (e.g., a query) received by the particular expert. Then, the particular expert may obtain the per-RAG embedding distance by aggregating (e.g., averaging) the per-item embedding distances. The expert may terminate performing its RAG process (e.g., the RAG process 106), if the per-RAG embedding distance exceeds the threshold value, meaning the retrieved information is too dissimilar to the input(s) and is therefore unlikely to be relevant to the input(s).

Inter-expert termination is performed in part by the orchestrator 404 and in part by each of the experts 406. For example, the orchestrator 404 may instruct the experts 406 to calculate an embedding score based at least in part on the retrieved information (e.g., one or more documents) and the input(s) received by the expert, and forward the embedding score to the orchestrator 404. The embedding score may include or be based at least in part on a per-RAG embedding distance calculated, by the particular expert, between the retrieved information and the input(s) received by the expert as described herein. Then, the orchestrator 404 may compare the embedding scores received from the experts 406, and decide which of the experts 406 should terminate and which of the experts 406 should generate prompt(s) and invoke the LM(s). For example, the orchestrator 404 may decide that a number of experts that returned embedding scores indicating that they retrieved the most relevant information should perform the full RAG process, and others of the experts 406 should terminate performing their respective RAG processes. By way of another non-limiting example, the orchestrator 404 may compare the embedding scores received from the experts 406 to a threshold value, and decide which of the experts 406 are to perform the full RAG process and which of the experts 406 are to terminate performing the RAG process based upon the results of this comparison. By way of yet another non-limiting example, any experts that returned an embedding score that exceeds the threshold value, may be instructed by the orchestrator 404 to terminate, and any experts that returned an embedding score that does not exceed the threshold value may be instructed by the orchestrator 404 to complete the RAG process. The orchestrator 404 may notify the experts 406 of these decisions, and the experts 406 may proceed in accordance with the decisions made by the orchestrator 404.

In at least one embodiment, the input(s) 402 may include an indication identifying one or more of the strategies to be applied by the orchestrator 404 and/or the experts 406 to produce the answer(s) 412. In at least one embodiment, a range of experts may be identified for use with a strategy to be applied. As an example, the orchestrator 404 may use the experts 406-1 and expert 406-2 to perform the post-retrieval early termination strategy, and the orchestrator 404 may use one or more others of the experts 406, such as the expert 3 406-3 to the expert k 406-k, to perform the pre-facto expert selection strategy. In at least one embodiment, the orchestrator 404 may select and/or implement a strategy based, at least in part, on a complexity of the input(s) 402, an expected performance (e.g., latency) of one or more neural networks (e.g., one or more of the NNs 304 illustrated in FIG. 3), and/or one or more user inputs (e.g., including one or more identifications of strategies to be used).

One or more strategies may be used alone or may be used in combination to implement a hybrid approach. As an example, inter-expert termination and intra-expert termination may be combined. By way of a non-limiting example, if the experts 406 include 10 individual experts, the orchestrator 404 may perform a multi-class multi-label classification on the input(s) 402, match the classes generated by the classification to experts 406-1 to 406-4 of the 10 experts (e.g., prioritize the four experts for recall) without knowing whether any of the experts has an answer. After the orchestrator 404 sends input(s) to the first expert 406-1, the first expert 406-1 may perform retrieval (e.g., using the retriever 408-1), decide that the first expert 406-1 does not have access to content that is relevant to the input(s), and terminate early. For example, the first expert 406-1 may calculate a per-item embedding scores by calculating an embedding distance between the input(s) received by the first expert 406-1 and each item retrieved by the first expert 406-1. Then, the first expert 406-1 may calculate a per-RAG embedding score (e.g., by aggregating the per-item embedding scores), and compare the per-RAG embedding score to a threshold value. Alternatively or additionally, the first expert 406-1 may compare the per-item embedding scores to a first threshold value to determine which, if any, of the items is/are relevant to the input(s) received by the first expert 406-1, and may determine the information retrieved by the first expert 406-1 is not relevant if fewer than a second threshold number of the items are determined to be relevant to the input(s) received by the first expert 406-1. If, as in this example, the information retrieved by the first expert 406-1 is determined not to be relevant (e.g., the per-RAG embedding score is greater than the threshold value), the first expert 406-1 may terminate the RAG process, and may notify the orchestrator 404 that the first expert 406-1 has terminated the RAG process.

After the orchestrator 404 sends input(s) to the second, third, and fourth experts 406-2, 406-3, and 406-4, these experts may each may perform retrieval (e.g., using the retriever 408-1), calculate per-item embedding scores, and compare the per-item embedding scores or at least one value based at least in part on the per-item embedding scores to a threshold value. If, as in this example, the results of the comparisons indicate information retrieved by the second, third, and fourth experts 406-2, 406-3, and 406-4 is relevant, the second, third, and fourth experts 406-2, 406-3, and 406-4 may each return the per-item embedding scores to the orchestrator 404. Because the second, third, and fourth experts 406-2, 406-3, and 406-4 returned per-item embedding scores to the orchestrator 404, the orchestrator 404 may compare the per-item embedding scores to one another. In this example, the orchestrator 404 decides to receive results from only the third expert 406-3 and the fourth expert 406-4. For example, the orchestrator 404 may decide to receive result from only a predetermined number (e.g., one, two, three, four, etc.) of the experts. Then, the orchestrator 404 gives green lights to the third and fourth experts 406-3 and 406-4 indicating these experts are to continue performing their respective RAG processes, and red lights the other experts (e.g., the second expert 406-2) indicating these experts are to terminate their respective RAG processes. The third and fourth experts 406-3 and 406-4 may go on to build their respective prompt(s), and invoke their respective LM(s) to generate one or more responses. The orchestrator 404 may receive responses from the third and fourth experts 406-3 and 406-4, and use one or more LM(s) to generate the answer(s) 412 based at least on those responses.

In at least one embodiment, the system 400 includes one or more processors to receive, by an orchestrator conversational AI (e.g., chat bot), one or more inputs; use, by the orchestrator conversational AI, one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, the system 400 is included in, and/or otherwise includes systems illustrated in any of FIGS. 1-8 and/or described with respect to any of FIGS. 1-8, to receive, by an orchestrator conversational AI, one or more inputs; use, by the orchestrator conversational AI, one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, the system 400 performs one or more processes illustrated in any of FIGS. 1-8 and/or described with respect to any of FIGS. 1-8, such as to receive, by an orchestrator conversational AI, one or more inputs; use, by the orchestrator conversational AI, one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, the system 400 includes one or more hardware illustrated in FIGS. 9A-11, such as to receive, by an orchestrator conversational AI, one or more inputs; use, by the orchestrator conversational AI, one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein.

In at least one embodiment, each of the experts 406 may have access to information related to one or more topics, such as human resources (HR), benefits, finance, general (unclassified), logistics, news, technologies, legal, security, and/or others. As an example, finance as a topic may include SEC filings, public blogs, publications (e.g., press releases), publicly available financial information, and/or other financial information. General as a topic may include, for example, brand information, company strategy information, information related to contracts, information related to employee marketing, information available on or related to a company website, and/or other general information. By way of non-limiting examples, logistics as a topic may include information related to employee finance, information related to shipping and/or receiving, a corporate calendar, information related to collaboration (e.g., with one or more other companies and/or organizations), information related to environmental health and safety, travel information, information related to global security, information related to site services, and/or other information. News as a topic may include, for example, information and/or updates relevant to one or more particular regions, such as one or more geographic regions, and/or one or more other types of information. As an example, technologies as a topic may include developer blogs, technical documents, and/or other information. By way of additional non-limiting examples, policies as a topic may include legal policies, information related to patents, information related to trademarks, information related to information security, information related to data privacy, and/or other information.

Now referring to FIG. 5A, each block of a method 500, described herein, includes a computing process that may be performed using any combination of hardware, firmware, and/or software. For instance, various functions may be carried out using one or more processors executing instructions stored in one or more memories. The method 500 may also be embodied as computer-usable instructions stored on computer storage media. The method 500 may be provided by a standalone application, a service or hosted service (standalone or in combination with another hosted service), as a microservice via an application programming interface (API) or a plug-in to another product, to name a few. In addition, the method 500 is described, by way of example, with respect to the system of FIG. 1. However, the method 500 may additionally or alternatively be executed by any one system, or any combination of systems, including, but not limited to, those described herein.

The method 500 may be performed by the system 100 (see FIG. 1). By way a non-limiting example, the orchestrator conversational AI functionality 120 (see FIG. 1) may perform at least a portion of the method 500. One or more portions of the method 500 may be performed by the neural networks 304 (see FIG. 3), the merge process described herein, and/or the task planner and/or router 306 (see FIG. 3). At least a portion of the method 500 may be performed by the system 400.

FIG. 5A is a flow diagram illustrating the method 500 of using an orchestrator to obtain output in response to one or more inputs, in accordance with some embodiments of the present disclosure. The method 500, at block 502, includes receiving one or more inputs from the requestor(s) 103 (see FIG. 1). As an example, the input(s) received (e.g., the input(s) 201 illustrated in FIG. 2, and/or the input(s) 402 illustrated in FIG. 4) may include one or more queries. An orchestrator (e.g., the orchestrator agent 204 or the orchestrator 404) may receive the input(s) (e.g., a query) in block 502.

The method 500, at block 504, includes implementing at least one strategy, such as the post-facto expert selection strategy, the pre-facto expert selection strategy (see FIG. 5B), and/or the post-retrieval early termination strategy (e.g., the intra-expert post-retrieval early termination strategy, the inter-expert post-retrieval early termination strategy, or combinations thereof). For example, at block 504, the orchestrator may select and implement the selected strategy(ies). In at least one embodiment, the requestor(s) 103 specify the strategy(ies) to be implemented by the orchestrator.

To implement the strategy(ies), the orchestrator may perform the chat history and personal context management process 204A, the question understanding and validation process 204B, the question routing process 204C, and/or the answer collection process 204D at block 504. By way of another non-limiting example, one or more of the NN(s) 304 may perform one or more portions of block 504. As an example, at block 504, the orchestrator may perform content understanding with respect to the input(s) received at block 502, analyzing the input(s) to determine subject matter and/or context (e.g., by performing the chat history and personal context management process 204A, by performing the question understanding and validation process 204B, by using the guard-railing NN(s) 304A, and/or by using the chat history and/or query contextualization NN(s) 304B). The orchestrator may use the subject matter and/or context associated with the input(s) received from the requestor(s) 103 to generate one or more expert inputs to be input into one or more of the experts. The expert inputs to be input into different experts may be identical to one another or at least one of the expert inputs may be different from the others. For example, the orchestrator may use information about the experts to tailor the expert inputs. In at least one embodiment, the expert inputs include the input(s) received from the requestor(s) 103. The orchestrator may route the expert input(s) to one or more experts (e.g., the set 212 of expert agents illustrated in FIG. 2, the domain experts 308 illustrated in FIG. 3, and/or the experts 406 illustrated in FIG. 4) in accordance with the strategy(ies) selected. The expert input(s) routed to the expert(s) may include the input(s) received at block 502, the output of the chat history and/or query contextualization NN(s) 304B, and/or one or more values determined based on the input(s) received at block 502 and/or the output of the chat history and/or query contextualization NN(s) 304B.

The method 500, at block 508, may include receiving the results generated by the expert(s) and optionally modifying the results obtained from one or more of the experts. As an example, the orchestrator may generate combined results by merging results (e.g., using the merge process) obtained from two or more of the selected experts, and/or using one or more LMs (e.g., the embedding reranker NN(s) 304D and/or the answer summarization NN(s) 304E) to summarize the merged results. In at least one embodiment, the orchestrator may provide the results obtained by a first selected expert as input to a second selected expert. In such embodiments, the orchestrator may use the output of the second selected expert and may ignore the results obtained by the first selected expert.

The method 500, at block 510, may include generating an orchestrator answer (e.g., the output 216, the final response 314, and/or the answer(s) 412), and outputting this answer to the requestor(s) 103 (e.g., via an interface, such as the interface 202). At this point, the method 500 may perform one or more operations described herein, and/or proceed to end.

In at least one embodiment, some or all of method 500 (or any other processes described herein, or variations and/or combinations thereof) is performed under control of one or more computer systems configured with computer executable instructions and is implemented as code (e.g., computer executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. As an example, computer-readable storage medium is a non-transitory computer-readable medium. At least some computer-readable instructions usable to perform method 500 may not be stored solely using transitory signals (e.g., a propagating transient electric or electromagnetic transmission). As an example, a non-transitory computer-readable medium does not necessarily include non-transitory data storage circuitry (e.g., buffers, caches, and queues) within transceivers of transitory signals. In at least one embodiment, method 500 is performed at least in part on a computer system such as those described elsewhere in this disclosure. In at least one embodiment, logic (e.g., hardware, software, or a combination of hardware and software) performs method 500.

In at least one embodiment, one or more processors use(s) the method 500, such as to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, as an example, a machine readable medium (e.g., non-transitory) having stored thereon a set of instructions, which if performed by one or more processors, cause one or more processors to perform method 700, such as to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, method 500 is, is included in, and/or otherwise includes processes illustrated in FIGS. 1-8 to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, one or more systems illustrated in FIGS. 1-8 perform method 500, such as to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, one or more hardware illustrated in FIGS. 9A-11 use method 500, such as to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise performs operations described herein.

Now referring to FIG. 5B, each block of a method 520, described herein, includes a computing process that may be performed using any combination of hardware, firmware, and/or software. For instance, various functions may be carried out using one or more processors executing instructions stored in one or more memories. The method 520 may also be embodied as computer-usable instructions stored on computer storage media. The method 520 may be provided by a standalone application, a service or hosted service (standalone or in combination with another hosted service), as a microservice via an application programming interface (API) or a plug-in to another product, to name a few. In addition, the method 520 is described, by way of example, with respect to the system of FIG. 1. However, the method 520 may additionally or alternatively be executed by any one system, or any combination of systems, including, but not limited to, those described herein.

The method 520 may be performed by the system 100 (see FIG. 1). By way a non-limiting example, the orchestrator conversational AI functionality 120 (see FIG. 1) may perform at least a portion of the method 520. One or more portions of the method 520 may be performed by the neural networks 304 (see FIG. 3), the merge process described herein, and/or the task planner and/or router 306 (see FIG. 3). At least a portion of the method 520 may be performed by the system 400.

FIG. 5B is a flow diagram illustrating the method 520 of implementing a pre-facto expert selection strategy, in accordance with some embodiments of the present disclosure. By way of a non-limiting example, the method 520 may be performed in block 504 (see FIG. 5A) of the method 500 (see FIG. 5A). The method 520, at block 522, includes obtaining a selection of the pre-facto expert selection strategy. An orchestrator (e.g., the orchestrator agent 204 or the orchestrator 404) may select the pre-facto expert selection strategy, for example, if input(s) received from the requestor(s) 103 (e.g., at block 502 illustrated in FIG. 5A) relate to readily determinable subject matter, the input(s) include less complex queries, the input(s) include query(ies) within the scope of a single expert, and/or for other reasons. In at least one embodiment, the orchestrator receives a selection of the pre-facto expert selection strategy from the requestor(s) 103.

The method 520, at block 524, may include selecting one or more relevant experts (e.g., the set 212 of expert agents illustrated in FIG. 2). At block 524, the orchestrator may classify the input(s) received from the requestor(s) 103, and/or match the input(s) with one or more experts. By way of a non-limiting example, the orchestrator may perform the chat history and personal context management process 204A, and/or the question understanding and validation process 204B at block 524. By way of another non-limiting example, the guard-railing NN(s) 304A, the chat history and/or query contextualization NN(s) 304B, and/or the pre-facto expert selection NN(s) 304C may perform one or more portions of block 524.

As an example, at block 524, the orchestrator performs content understanding with respect to the input(s) received from the requestor(s) 103, analyzing the input(s) to determine subject matter and/or context (e.g., by performing the chat history and personal context management process 204A, by performing the question understanding and validation process 204B, by using the guard-railing NN(s) 304A, and/or by using the chat history and/or query contextualization NN(s) 304B). At block 524, the orchestrator (e.g., performing the question routing process 204C, using the pre-facto expert selection NN(s) 304C, and/or using the task planner and/or router 306) may use the output of the chat history and/or query contextualization NN(s) 304B to assign one or more classifications to the input(s) received from the requestor(s) 103. Then, the orchestrator may select, as the relevant expert(s), one or more experts associated with subject matter that overlaps with the classification(s) assigned to the input(s).

The method 520, at block 526, may include causing the relevant expert(s) selected in block 524 to perform a full RAG process (e.g., the RAG process 106 illustrated in FIG. 1) while any remaining experts (e.g., experts not considered to be relevant to the input(s) received from the requestor(s) 103) remain idle. For example, the orchestrator may route expert input(s) to each of the selected expert(s) (e.g., by performing the question routing process 204C, using the pre-facto expert selection NN(s) 304C, and/or using the task planner and/or router 306). The input(s) routed to the selected expert(s) may include the input(s) received from the requestor(s) 103, the output of the chat history and/or query contextualization NN(s) 304B, and/or one or more values determined based on the input(s) received from the requestor(s) 103 and/or the output of the chat history and/or query contextualization NN(s) 304B. At block 506, the orchestrator may instruct the selected experts to perform a full RAG process, and may instruct others of the experts to remain idle or cause the other experts to remain idle by not instructing them to take any actions. The selected expert(s) may output results (e.g., one or more answers) to the orchestrator generated by performing the RAG process.

At this point, the method 520 may perform one or more operations described herein, and/or proceed to end. In some embodiments, block 506 (see FIG. 5A) of the method 500 (see FIG. 5A) may be performed after the method 520 ends.

Now referring to FIG. 6, each block of the method 600, described herein, includes a computing process that may be performed using any combination of hardware, firmware, and/or software. For instance, various functions may be carried out using one or more processors executing instructions stored in one or more memories. The method 600 may also be embodied as computer-usable instructions stored on computer storage media. The method 600 may be provided by a standalone application, a service or hosted service (standalone or in combination with another hosted service), as a microservice via an application programming interface (API) or a plug-in to another product, to name a few. In addition, the method 600 is described, by way of example, with respect to the system of FIG. 1. However, the method 600 may additionally or alternatively be executed by any one system, or any combination of systems, including, but not limited to, those described herein.

The method 600 may be performed by the system 100 (see FIG. 1). By way a non-limiting example, the orchestrator conversational AI functionality 120 (see FIG. 1) and/or the expert conversational AI functionality 132 (see FIG. 1) may perform at least a portion of the method 600. One or more portions of the method 600 may be performed by the neural networks 304 (see FIG. 3), the merge process described herein, and/or the task planner and/or router 306 (see FIG. 3). At least a portion of the method 600 may be performed by the system 400.

FIG. 6 is a flow diagram illustrating the method 600 of implementing an intra-expert post-retrieval early termination strategy, in accordance with some embodiments of the present disclosure. The method 600, at block 602, includes obtaining a selection of the intra-expert post-retrieval early termination strategy. An orchestrator (e.g., the orchestrator agent 204 or the orchestrator 404) may select the intra-expert post-retrieval early termination strategy, for example, to reduce usage of computing resources (e.g., if the system 100 is experiencing latency, and/or the input(s) received from the requestor(s) 103 indicate obtaining response(s) would consume significant computing resources), and/or for other reasons. For example, the question understanding and validation process 204B may assign a latency indicator and/or a computational resource consumption indicator to the input(s) received from the requestor(s) 103, and the orchestrator may determine whether to select the inter-expert post-retrieval early termination strategy based at least on the latency indicator and/or the computational resource consumption indicator. In at least one embodiment, the orchestrator receives a selection of the intra-expert post-retrieval early termination strategy from the requestor(s) 103. The intra-expert post-retrieval early termination strategy may involve requesting responses from all of the experts or a subset of the experts. For example, the orchestrator may perform operations described with respect to block 524 (see FIG. 5A) to select one or more of the experts. Alternatively, the orchestrator may select all of the experts.

The method 600, at block 604, may include routing the expert input(s) to the selected experts. For example, the orchestrator may route expert input(s) to each of the selected expert(s) (e.g., by performing the question routing process 204C, using the pre-facto expert selection NN(s) 304C, and/or using the task planner and/or router 306). The expert input(s) routed to the selected expert(s) may include an instruction instructing the selected experts to perform intra-expert post-retrieval early termination, the input(s) received from the requestor(s) 103, the output of the chat history and/or query contextualization NN(s) 304B, and/or one or more values determined based on the input(s) received from the requestor(s) 103 and/or the output of the chat history and/or query contextualization NN(s) 304B. The method 600, at block 606, may include each of the selected experts attempting to retrieve relevant documents. For example, each of the selected experts may query its associated data source(s) for information. At block 606, the selected experts may perform the query understanding process 106A, and/or the information retrieval process 106B. At block 606, each of the selected experts may use their respective retrievers (e.g., one of the retrievers 408) to attempt to obtain information from data source(s) (e.g., the data source(s) 410) associated with the selected expert.

The method 600, at decision block 608, may include each of the selected experts determining whether the selected expert located a sufficient amount of relevant information. After an expert attempts to retrieve information from its associated data store(s) (e.g., database(s), data lake(s), and/or one or more other types of data stores), at decision block 608, the expert determines whether any information retrieved is relevant to the expert input(s) provided to the expert by the orchestrator (e.g., to the input(s) received from the requestor(s) 103). As an example, the decision at decision block 608, is “YES,” if the selected expert retrieves one or more relevant documents and/or determines using a vector embedding that one or more relevant documents are present. Otherwise, a decision at decision block 608 is “NO,” and the select expert terminates performance of the RAG process at block 610. If the decision at decision blocks 608 is “YES,” at block 612, the select expert generates results by completing the RAG process (e.g., generates prompt(s), provides the prompt(s) to at least one neural network, and uses the neural network(s) to generate the results). Thus, an expert may perform the full RAG process if an expert retrieved relevant information or otherwise terminate the RAG process, at block 610. At block 610, the expert may notify the orchestrator that the expert was unable to retrieve relevant information. The expert(s) that produced one or more results (e.g., generated an expert answer), at block 612, may provide those results to the orchestrator.

The selected experts may perform blocks 606-612 in parallel.

In at least one embodiment, upon performing block 610 and/or block 614, such as by one or more experts in parallel, the method 600 may include performing one or more operations described herein and/or proceeding to end. In some embodiments, block 506 (see FIG. 5A) of the method 500 (see FIG. 5A) is performed after the method 600 ends. In at least one embodiment, the orchestrator conversational AI functionality 120 (see FIG. 1) performs blocks 602-604, and/or the expert conversational AI functionality 132 (see FIG. 1) performs blocks 606-612.

In at least one embodiment, some or all of the method 600 (or any other processes described herein, or variations and/or combinations thereof) is performed under control of one or more computer systems configured with computer executable instructions and is implemented as code (e.g., computer executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. As an example, computer-readable storage medium is a non-transitory computer-readable medium. At least some computer-readable instructions usable to perform method 600 may not be stored solely using transitory signals (e.g., a propagating transient electric or electromagnetic transmission). As an example, a non-transitory computer-readable medium does not necessarily include non-transitory data storage circuitry (e.g., buffers, caches, and queues) within transceivers of transitory signals. In at least one embodiment, method 600 is performed at least in part on a computer system such as those described elsewhere in this disclosure. In at least one embodiment, logic (e.g., hardware, software, or a combination of hardware and software) performs the method 600.

In at least one embodiment, one or more processors use(s) the method 600, such as to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, as an example, a machine readable medium (e.g., non-transitory) having stored thereon a set of instructions, which if performed by one or more processors, cause one or more processors to perform method 600, such as to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, method 600 is, is included in, and/or otherwise includes processes illustrated in FIGS. 1-8 to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, one or more systems illustrated in FIGS. 1-8 perform method 600, such as to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, one or more hardware illustrated in FIGS. 9A-11 use method 600, such as to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise performs operations described herein.

Now referring to FIG. 7, each block of the method 700, described herein, includes a computing process that may be performed using any combination of hardware, firmware, and/or software. For instance, various functions may be carried out using one or more processors executing instructions stored in one or more memories. The method 700 may also be embodied as computer-usable instructions stored on computer storage media. The method 700 may be provided by a standalone application, a service or hosted service (standalone or in combination with another hosted service), as a microservice via an application programming interface (API) or a plug-in to another product, to name a few. In addition, the method 700 is described, by way of example, with respect to the system of FIG. 1. However, the method 700 may additionally or alternatively be executed by any one system, or any combination of systems, including, but not limited to, those described herein.

The method 700 may be performed by the system 100 (see FIG. 1). By way a non-limiting example, the orchestrator conversational AI functionality 120 (see FIG. 1) and/or the expert conversational AI functionality 132 (see FIG. 1) may perform at least a portion of the method 700. One or more portions of the method 700 may be performed by the neural networks 304 (see FIG. 3), the merge process described herein, and/or the task planner and/or router 306 (see FIG. 3). At least a portion of the method 700 may be performed by the system 400.

FIG. 7 is a flow diagram illustrating the method 700 of implementing an inter-expert post-retrieval early termination strategy, in accordance with some embodiments of the present disclosure. The method 700, at block 702, may include obtaining a selection of the inter-expert post-retrieval early termination strategy. An orchestrator (e.g., the orchestrator agent 204 or the orchestrator 404) may select the inter-expert post-retrieval early termination strategy, for example, to reduce usage of computing resources (e.g., if the system 100 is experiencing latency, and/or the input(s) received from the requestor(s) 103 indicate obtaining response(s) would consume significant computing resources and/or increase latency), and/or for other reasons. For example, the question understanding and validation process 204B may assign a latency indicator and/or a computational resource consumption indicator to the input(s) received from the requestor(s) 103, and the orchestrator may determine whether to select the inter-expert post-retrieval early termination strategy based at least on the latency indicator and/or the computational resource consumption indicator. In at least one embodiment, the orchestrator receives a selection of the inter-expert post-retrieval early termination strategy from the requestor(s) 103. The inter-expert post-retrieval early termination strategy may involve requesting responses from all of the experts or a subset of the experts. For example, the orchestrator may perform operations described with respect to block 524 (see FIG. 5A) to select one or more of the experts. Alternatively, the orchestrator may select all of the experts

The method 700, at block 704, includes routing the expert input(s) to the selected experts. For example, the orchestrator may route expert input(s) to each of the selected expert(s) (e.g., by performing the question routing process 204C, using the pre-facto expert selection NN(s) 304C, and/or using the task planner and/or router 306). The expert input(s) routed to the selected expert(s) may include an instruction instructing the selected experts to perform inter-expert post-retrieval early termination, the input(s) received from the requestor(s) 103, the output of the chat history and/or query contextualization NN(s) 304B, and/or one or more values determined based on the input(s) received from the requestor(s) 103 and/or the output of the chat history and/or query contextualization NN(s) 304B.

The method 700, at block 706, includes each of the selected experts attempting to retrieve relevant information, and, if at least one item of information was retrieved, calculating a per-item embedding score for each item of retrieved information. For example, each of the selected experts may query its associated data source(s) for information, for example, using a retriever (e.g., one of the retrievers 408) to attempt to obtain information from data source(s) (e.g., the data source(s) 410) associated with the selected expert. For example, at block 706, the selected experts may perform the query understanding process 106A, and/or the information retrieval process 106B. Any of the selected experts that retrieved at least one item of information may determine the per-item embedding score(s) by calculating a per-item embedding distance between the expert input(s) received by the selected expert, and each item of information retrieved by the selected expert. Any of the selected experts that retrieved at least one item of information may determine a per-RAG embedding score by aggregating (e.g., totaling, averaging, etc.) the per-item embedding score(s) determined by the select expert.

The method 700, at block 708, includes at least a portion of the selected expert(s) providing (e.g.,, transmitting) their respective data to the orchestrator. For each expert, that data may include embedding score(s) (e.g., the per-item embedding score(s) and/or the per-RAG embedding score) and/or the information retrieved by the expert. Each of any of the selected expert(s) that did not locate any information may send a notification to the orchestrator indicating that the selected expert did not locate any relevant information. In at least one embodiment, any of the selected expert(s) that did not locate any information will terminate performance of the RAG process with respect to the expert input(s) sent to the selected expert at block 704.

The method 700, at block 710, includes determining which of the selected experts are to return results, and which of the selected experts are to terminate performance of the RAG process with respect to the expert input(s) sent to the selected expert at block 704. For example, the orchestrator may receive the data for each of one or more experts (e.g., the embedding score(s) and/or information retrieved by the expert) and use the data to determine whether the expert is to complete or terminate the RAG process. In embodiments in which the orchestrator receives the per-item embedding score(s), the orchestrator may aggregate (e.g., total, average, etc.) the per-item embedding score(s) to obtain a per-RAG embedding score(s). By way of a non-limiting example, the orchestrator 404 may compare the embedding score(s) (e.g., the per-item embedding score(s) and/or the per-RAG embedding score), and decide which of the experts are to complete or terminate their respective RAG processes based at least on results of the comparison. For example, the orchestrator 404 may decide that a number of experts that returned embedding score(s) indicating that they retrieved the most relevant information should perform the full RAG process, and others of the experts should terminate their respective RAG processes. By way of another non-limiting example, the orchestrator 404 may compare the embedding score(s) to a threshold value, and decide which of the experts are to perform the full RAG process and which of the experts 406 are to terminate their respective RAG processes based upon the results of this comparison. By way of yet another non-limiting example, the orchestrator may decide that each of the experts associated with embedding score(s) that exceed(s) the threshold value may terminate its respective RAG process, and each of any of the experts associated with one or more embedding score(s) that do/does not exceed the threshold value is to complete its respective RAG process. Any of the experts that the orchestrator determined are to complete the RAG process, are referred to as relevant experts.

The method 700, at block 712, may include causing the relevant expert(s) to generate results. For example, the orchestrator may instruct the relevant expert(s) to continue performing the RAG process. As an example, at block 712, the orchestrator may instruct the relevant expert(s) to produce results and provide those results to the orchestrator, which may assemble (e.g., aggregate) the results to generate output. In at least one embodiment, the orchestrator notifies any of the selected expert(s) that is not a relevant expert, to terminate the RAG process. The method 700, at block 714, includes the relevant expert(s) generating results. For example, at block 714, the relevant expert(s) may generate results by completing the RAG process (e.g., generates prompt(s), provides the prompt(s) to at least one neural network, and uses the neural network(s) to generate the results). Thus, an expert may perform the full RAG process if an expert retrieved relevant information or otherwise terminate the RAG process, at block 706. Any of the relevant expert(s) that produces one or more results (e.g., generated an expert answer), at block 714, may provide the results to the orchestrator. As an example, the method 700 may include the orchestrator comparing information obtained from one or more of the experts jointly, which may then be used to decide which of the expert(s) is to terminate early or perform the full RAG process to generate results (e.g., using its LM(s)).

The selected expert(s) may perform block 706 and/or block 708 in parallel. Any of the selected expert(s) determined by the orchestrator to be relevant may perform the block 714 in parallel.

Upon performance of block 714, the method 700 may include performing one or more operations described herein, and/or may end. In some embodiments, block 506 (see FIG. 5A) of the method 500 (see FIG. 5A) is performed after the method 700 ends. In at least one embodiment, the orchestrator conversational AI functionality 120 (see FIG. 1) performs blocks 702, 704, 710, and 712. In at least one embodiment, the expert conversational AI functionality 132 (see FIG. 1) performs blocks 706, 708, and 714.

The method 700 may also be used in combination with one or more other strategies, such at the post-facto expert selection strategy, the pre-facto expert selection strategy implemented by the method 520 (see FIG. 5B), and/or the intra-expert post-retrieval early termination strategy implemented by the method 600 (see FIG. 6). As an example, the orchestrator may instruct an expert to perform a combination of the intra-expert and inter-expert post-retrieval strategies. Such as where an expert self-determines whether it has retrieved information relevant to the expert input(s) received by the expert, and, if the expert determines it has retrieved relevant information or if an expert is uncertain, the expert may forward the retrieved information to the orchestrator, which determines (e.g., by performing a cross comparison operation) whether the expert is to perform the full RAG process and generate results (e.g., using its LM(s)). The cross comparison operation may calculate similarity metric values between the expert input(s) and the retrieved information, and select results based on a comparison of the similarity metric values with a learned threshold value. Otherwise, if the information is determined to not be relevant by either the expert or orchestrator, the expert may terminate early without generating results (e.g., using neural network(s), such as LM(s)). By way of another non-limiting example of implementing a combined intra-expert and inter-expert approach, if an expert determines that the retrieved information is relevant, the expert may generate results (e.g., with LM(s)) without additional input from the orchestrator. The orchestrator may implement orchestration patterns that are predetermined, received as user input, and/or automatically adjusted at runtime. These patterns may obtain output (e.g., an answer to a query) by providing the results obtained from at least one first expert to at least one second expert as input.

In at least one embodiment, some or all of the method 700 (or any other processes described herein, or variations and/or combinations thereof) is performed under control of one or more computer systems configured with computer executable instructions and is implemented as code (e.g., computer executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. As an example, computer-readable storage medium is a non-transitory computer-readable medium. At least some computer-readable instructions usable to perform method 700 may not be stored solely using transitory signals (e.g., a propagating transient electric or electromagnetic transmission). As an example, a non-transitory computer-readable medium does not necessarily include non-transitory data storage circuitry (e.g., buffers, caches, and queues) within transceivers of transitory signals. In at least one embodiment, method 700 is performed at least in part on a computer system such as those described elsewhere in this disclosure. In at least one embodiment, logic (e.g., hardware, software, or a combination of hardware and software) performs the method 700.

In at least one embodiment, one or more methods 500, 600, and/or 700 are performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; a system implemented at least partially using cloud computing resources; and/or combinations thereof.

In at least one embodiment, one or more processors uses method 700, such as to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, as an example, a machine readable medium (e.g., non-transitory) having stored thereon a set of instructions, which if performed by one or more processors, cause one or more processors to perform method 700, such as to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, method 700 is, is included in, and/or otherwise includes processes illustrated in FIGS. 1-8 to receive, by an orchestrator conversational AI, one or more user inputs; use, by an orchestrator conversational Artificial Intelligence (AI), one or more strategies to obtain one or more responses from one or more expert conversational Als based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, one or more systems illustrated in FIGS. 1-8 perform method 700, such as to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, one or more hardware illustrated in FIGS. 9A-11 use method 700, such as to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise performs operations described herein.

With reference to FIG. 8, FIG. 8 is an example processor and storage, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 9A-9C), one or more computing devices or components thereof (e.g., as described in FIG. 10), and/or one or more data centers or components thereof (e.g., as described in FIG. 11).

FIG. 8 illustrates an example of a system 800 that can include software and hardware to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses; and/or otherwise perform any of the operations described herein, according to at least one embodiment. The system 800 can include storage 802 and processor(s) 808. Storage 802 can include, for example, memory, cache, or other storage described further herein. Storage 802 can be separate from processor(s) 808, or storage 802 can be included in processor(s) 808 (e.g., in storage 812). In at least one embodiment, software program 804 and/or software libraries (or instructions) 806 can be stored in memory, cache, or other storage and provided to processor(s) 808 to cause one or more circuits of processor(s) 808 (e.g., processing circuitry) to perform operations described herein. In at least one embodiment, software program 804 and/or software libraries (or instructions) 806 can be integrated into one or more circuits of processor(s) 808. Software program 804, which can be used to perform any of the operations described herein, may be stored on storage 802.

In at least one embodiment, software program 804 can include one or more software modules. In at least one embodiment, one or more modules are to perform or implement a conversation AI, to use an orchestrator, use one or more expert agents, and/or identify one or more strategies to use to perform retrieval augmented generation.

In at least one embodiment, as used in any implementation described herein, unless otherwise clear from context or stated explicitly to contrary, a module refers to any combination of software logic, firmware logic, hardware logic, and/or circuitry configured to provide functionality described herein. In at least one embodiment, software is embodied as a software package, code and/or instruction set or instructions, and “hardware,” as used in any implementation described herein, includes, for example, singly or in any combination, hardwired circuitry, programmable circuitry, state machine circuitry, fixed function circuitry, execution unit circuitry, and/or firmware that stores instructions performed by programmable circuitry. In at least one embodiment, modules are, collectively or individually, embodied as circuitry that forms part of a larger system, for example, an integrated circuit (IC), system on-chip (SoC), and so forth. In at least one embodiment, a module performs one or more processes in connection with any suitable processing unit and/or combination of processing units, such as one or more CPUs, GPUS, GPGPUs, PPUs, and/or variations thereof including those further described herein.

In at least one embodiment, software program 804 can include a collection of software code, commands, instructions, or other sequences of text to instruct a computing device to perform one or more computational operations and/or invoke one or more other sets of instructions, such as API(s) or API function(s) or Instruction Set Architecture (ISA) level instructions, to be executed or otherwise performed. In at least one embodiment, instructions 806 includes orchestrator conversation AI functionality 832 (e.g., the orchestrator conversation AI functionality 120, see FIG. 1) and/or expert conversation AI functionality 834 (e.g., expert conversation AI functionality 132). Instructions (e.g., hardware instructions) or microcode can involve ISA level instructions, which can include native ISA instructions or non-native ISA instructions. Software program 804 and/or instructions 806 (e.g., one or more modules) can be distributed among multiple processors that communicate over a bus, network, by writing to shared memory, and/or any suitable communication process such as those described herein.

In at least one embodiment, system 800 can include one or more software libraries that can, for example, provide one or more APIs and/or ISA instructions. In at least one embodiment, one or more APIs and/or ISA instructions can be used to receive, by an orchestrator conversational Artificial Intelligence (AI), one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses. In at least one embodiment, one or more software libraries can be included in drivers and/or runtimes. In at least one embodiment, software libraries (e.g., including one or more APIs and/or ISA instructions) can include sets of software instructions that, if executed or otherwise performed, cause processor(s) 808 to perform one or more computational operations, such as any of the operations described herein. In at least one embodiment, one or more APIs and/or ISA instructions can be distributed or otherwise provided as a part of one or more software libraries, runtimes, drivers, and/or any other grouping of software and/or executable code further described herein. In at least one embodiment, one or more APIs and/or ISA instructions can perform one or more computational operations in response to invocation by software program 804.

Processor(s) 808 may include any number of processors and any suitable processing unit and/or combination of processing units, such as, but not limited to, central processing units (“CPUs”), graphics processing units (“GPUs”), or other processors (including accelerators, field programmable gate arrays (FPGAs), graphics processors, parallel processors, GPGPUs, DPUs, and/or variations thereof including those further described herein), including any processors described herein, such as, but not limited to, processors in FIGS. 1, 9A, 10 and 11. In at least one embodiment, processor(s) 808 can retrieve or fetch instructions (e.g., one or more APIs and/or ISA instructions) from storage 802 using, for example, instruction fetch 816 (e.g., for an Instruction Fetch stage). Instructions can include instructions to receive, by an orchestrator conversational Artificial Intelligence (AI), one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses. In at least one embodiment, processor(s) 808 can include storage 812 and instruction queue 810 to store and queue instructions fetched from storage 802. In at least one embodiment, fetched instructions can be decoded by decode 818 to determine what operation should be performed by processor(s) 808 (e.g., in an Instruction Decode stage). In at least one embodiment, processor(s) 808 can fetch additional operands (data) that may be used for instructions, and operands can be stored, e.g., in registers or storage 812. In at least one embodiment, micro-operations 820 can perform operations on data stored in one or more registers or storage 812. For example, each step of instructions fetched by processor(s) 808 can be decomposed during execution so processor(s) 808 can execute instructions in steps through a series of micro-operations 820. In at least one embodiment, program counter (PC) 814 can hold an address for a next instruction and can be updated to point to the next instruction to be executed by processor(s) 808.

In at least one embodiment, processor(s) 808 can perform instructions (e.g., in an Execution stage). For example, processor(s) 808 can perform an operation specified by the instructions, such as an arithmetic operation, a logical operation, or a data transfer. In at least one embodiment, compute unit(s) 822 can execute instructions to perform any of the operations described herein. In at least one embodiment, compute unit(s) can include ALU(s) 824 (Arithmetic Logic Units), which may be used for performing arithmetic and logical operations. In at least one embodiment, compute unit(s) can include FPU(s) (Floating Point Units) 826, which may be used for performing floating-point calculations. In at least one embodiment, other circuits 828 can be used to perform other operations, such as vector and/or scalar operations. In at least one embodiment, accelerator(s) 830 can include one or more matrix multiplication accelerators, one or more parallel processing units (PPUs), such as GPUs, or any other accelerator or processor further described herein. In at least one embodiment, software program 804 can utilize one or more APIs and/or ISA instructions to perform various computing operations with accelerator(s) 830, such as matrix multiplication, arithmetic operations, or any other computing operation further described herein. In at least one embodiment, one or more computing operations using accelerator(s) 830 can include at least one or more groups of computing operations to be accelerated by execution at least in part by accelerator(s) 830, including to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses.

In at least one embodiment, system 800 can be used to perform one or more instructions that include functions or operations, such as those described in connection with FIGS. 1-7. In at least one embodiment, system 800 comprising one or more processors causes one or more circuits to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses; and/or otherwise perform operations described herein. In at least one embodiment, system 800 is included in and/or otherwise includes systems illustrated in FIGS. 1-7 to cause one or more circuits to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, system 800 includes one or more hardware illustrated in FIGS. 9A-11, such as to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein.

In at least one embodiment, system 800 includes one or more processors to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, system 800 is, is included in, and/or otherwise includes systems illustrated in FIGS. 1-8 to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, system 800 performs one or more processes illustrated in FIGS. 1-8, such as to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein. In at least one embodiment, system 800 includes one or more hardware illustrated in FIGS. 9A-11, such as to receive, by an orchestrator conversational AI, one or more user inputs; use, by an orchestrator conversational Artificial Intelligence (AI), one or more strategies to obtain one or more responses from one or more expert conversational AIs based in part on one or more inputs received by the orchestrator conversational AI; and determine, by the orchestrator conversational AI, at least one answer to the one or more inputs based at least on a portion of the one or more responses, and/or otherwise perform operations described herein.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 9A is a block diagram of an example generative language model system 900 suitable for use in implementing at least some embodiments of the present disclosure. In the example illustrated in FIG. 9A, the generative language model system 900 includes a retrieval augmented generation (RAG) component 992, an input processor 905, a tokenizer 910, an embedding component 920, plug-ins/APIs 995, and a generative language model (LM) 930 (which may include an LLM, a VLM, a multi-modal LM, etc.).

At a high level, the input processor 905 may receive an input 901 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 930 (e.g., LLM/SLM/VLM/MMLM/etc.). In some embodiments, the input 901 includes plain text in the form of one or more sentences, paragraphs, and/or documents. Additionally or alternatively, the input 901 may include numerical sequences, precomputed embeddings (e.g., word or sentence embeddings), and/or structured data (e.g., in tabular formats, JSON, or XML). In some implementations in which the generative LM 930 is capable of processing multi-modal inputs, the input 901 may combine text (or may omit text) with image data, audio data, video data, design data, USD data, and/or other types of input data, such as but not limited to those described herein. Taking raw input text as an example, the input processor 905 may prepare raw input text in various ways. For example, the input processor 905 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 905 may remove stopwords to reduce noise and focus the generative LM 930 on more meaningful content. The input processor 905 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 992 (which may include one or more RAG models, and/or may be performed using the generative LM 930 itself) may be used to retrieve additional information to be used as part of the input 901 or prompt. RAG may be used to enhance the input to the LLM/SLM/VLM/MMLM/etc. with external knowledge, so that answers to specific questions or queries or requests are more relevant—such as in a case where specific knowledge is required. The RAG component 992 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 901 may be generated using the query or input to the model (e.g., a question, a request, etc.) in addition to data retrieved using the RAG component 992. In some embodiments, the input processor 905 may analyze the input 901 and communicate with the RAG component 992 (or the RAG component 992 may be part of the input processor 905, in embodiments) in order to identify relevant text and/or other data to provide to the generative LM 930 as additional context or sources of information from which to identify the response, answer, or output 990, generally. For example, where the input indicates that the user is interested in a desired tire pressure for a particular make and model of vehicle, the RAG component 992 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 992 may retrieve a prior stored conversation history—or at least a summary thereof—and include the prior conversation history along with the current ask/request as part of the input 901 to the generative LM 930.

The RAG component 992 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 992 and the embeddings of the chunks along with the embeddings of the query may be compared to identify the most similar/related embeddings to the query, which may be supplied to the generative LM 930 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding. As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 992 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 910 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy may depend on factors such as the language being processed, the task at hand, and/or characteristics of the training dataset. As such, the tokenizer 910 may convert the (e.g., processed) text into a structured format according to tokenization schema being implemented in the particular embodiment.

The embedding component 920 may use any known embedding technique to transform discrete tokens into (e.g., dense, continuous vector) representations of semantic meaning. For example, the embedding component 920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 901 includes image data/video data/etc., the input processor 901 may resize the data to a standard size compatible with format of a corresponding input channel and/or may normalize pixel values to a common range (e.g., 0 to 1) to ensure a consistent representation, and the embedding component 920 may encode the image data using any known technique (e.g., using one or more convolutional neural networks (CNNs) to extract visual features). In some implementations in which the input 901 includes audio data, the input processor 901 may resample an audio file to a consistent sampling rate for uniform processing, and the embedding component 920 may use any known technique to extract and encode audio features—such as in the form of a spectrogram (e.g., a mel-spectrogram). In some implementations in which the input 901 includes video data, the input processor 901 may extract frames or apply resizing to extracted frames, and the embedding component 920 may extract features such as optical flow embeddings or video embeddings and/or may encode temporal information or sequences of frames. In some implementations in which the input 901 includes multi-modal data, the embedding component 920 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 930 and/or other components of the generative LM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 920 may apply an encoded representation of the input 901 to the generative LM 930, and the generative LM 930 may process the encoded representation of the input 901 to generate an output 990, which may include responsive text and/or other types of data.

As described herein, in some embodiments, the generative LM 930 may be configured to access or use—or capable of accessing or using—plug-ins/APIs 995 (which may include one or more plug-ins, application programming interfaces (APIs), databases, data stores, repositories, etc.). For example, for certain tasks or operations that the generative LM 930 is not ideally suited for, the model may have instructions (e.g., as a result of training, and/or based on instructions in a given prompt, such as those retrieved using the RAG component 992) to access one or more plug-ins/APIs 995 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 995 to the plug-in/API 995, the plug-in/API 995 may process the information and return an answer to the generative LM 930, and the generative LM 930 may use the response to generate the output 990. This process may be repeated—e.g., recursively—for any number of iterations and using any number of plug-ins/APIs 995 until an output 990 that addresses each ask/question/request/process/operation/etc. from the input 901 can be generated. As such, the model(s) may not only rely on its own knowledge from training on a large dataset(s) and/or from data retrieved using the RAG component 992, but also on the expertise or optimized nature of one or more external resources—such as the plug-ins/APIs 995.

FIG. 9B is a block diagram of an example implementation in which the generative LM 930 includes a transformer encoder-decoder. For example, assume input text such as “Who discovered gravity” is tokenized (e.g., by the tokenizer 910 of FIG. 9A) into tokens such as words, and each token is encoded (e.g., by the embedding component 920 of FIG. 9A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 935 of the generative LM 930.

In an example implementation, the encoder(s) 935 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 940 may convert the context vector into attention vectors (keys and values) for the decoder(s) 945.

In an example implementation, the decoder(s) 945 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 935, in an example transformer architecture, each token (e.g., word) flows through a separate path in the decoder(s) 945. During a first pass, the decoder(s) 945, a classifier 950, and a generation mechanism 955 may generate a first token, and the generation mechanism 955 may apply the generated token as an input during a second pass. The process may repeat in a loop, successively generating and adding tokens (e.g., words) to the output from the preceding pass and applying the token embeddings of the composite sequence with positional encodings as an input to the decoder(s) 945 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 935, except that it creates its queries from the layer below it and takes the keys and values (e.g., matrix) from the output of the encoder(s) 935.

As such, the decoder(s) 945 may output some decoded (e.g., vector) representation of the input being applied during a particular pass. The classifier 950 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 955 may select or sample a word or token based on a corresponding predicted probability (e.g., select the word with the highest predicted probability) and append it to the output from a previous pass, generating each word or token sequentially. The generation mechanism 955 may repeat the process, triggering successive decoder inputs and corresponding predictions until selecting or sampling a symbol or token that represents the end of the response, at which point, the generation mechanism 955 may output the generated response.

FIG. 9C is a block diagram of an example implementation in which the generative LM 930 includes a decoder-only transformer architecture. For example, the decoder(s) 960 of FIG. 9C may operate similarly as the decoder(s) 945 of FIG. 9B except each of the decoder(s) 960 of FIG. 9C omits the encoder-decoder self-attention layer (since there is no encoder in this implementation). As such, the decoder(s) 960 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 960. As with the decoder(s) 945 of FIG. 9B, each token (e.g., word) may flow through a separate path in the decoder(s) 960, and the decoder(s) 960, a classifier 965, and a generation mechanism 970 may use auto-regression to sequentially generate one token at a time until predicting a symbol or token that represents the end of the response. The classifier 965 and the generation mechanism 970 may operate similarly as the classifier 950 and the generation mechanism 955 of FIG. 9B, with the generation mechanism 970 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMS), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140. As shown in FIG. 11, the data center infrastructure layer 1110 may include a resource orchestrator 1112, grouped computing resources 1114, and node computing resources (“node C.R. s”) 1116(1)-1116(N), where “N” represents any whole, positive integer. In at least one embodiment, node C.R. s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R. s from among node C.R. s 1116(1)-1116(N) may correspond to a server having one or more of the above-mentioned computing resources. In addition, in some embodiments, the node C.R. s 1116(1)-11161(N) may include one or more virtual components, such as vGPUs, vCPUs, and/or the like, and/or one or more of the node C.R. s 1116(1)-1116(N) may correspond to a virtual machine (VM).

In at least one embodiment, grouped computing resources 1114 may include separate groupings of node C.R. s 1116 housed within one or more racks (not shown), or many racks housed in data centers at various geographical locations (also not shown). Separate groupings of node C.R. s 1116 within grouped computing resources 1114 may include grouped compute, network, memory or storage resources that may be configured or allocated to support one or more workloads. In at least one embodiment, several node C.R. s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R. s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may use distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R. s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R. s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein. In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e .g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity. Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

At least one embodiment of the disclosure can be described in view of the following clauses:

Clause 1. A method comprising: using an orchestrator conversational Artificial Intelligence (AI) to execute one or more strategies to obtain one or more responses from one or more expert conversational AIs based in part on one or more inputs received by the orchestrator conversational AI; determining, by the orchestrator conversational AI, at least one answer to the one or more inputs based at least on a portion of the one or more responses; and causing at least one of audible or visual presentation of the at least one answer.

Clause 2. The method of clause 1, wherein the one or more strategies comprise at least a post-facto expert selection strategy in which the orchestrator conversational AI is to: instruct a set of the one or more expert conversational AIs to generate at least a subset of the one or more responses, select a relevant portion of the subset, and determine the at least one answer based at least on the relevant portion.

Clause 3. The method of clause 1 or 2, wherein the one or more strategies comprise at least a pre-facto expert selection strategy in which the orchestrator conversational AI is to: instruct a set of the one or more expert conversational AIs to generate at least a subset of the one or more responses, and determine the at least one answer based at least on the subset of the one or more responses.

Clause 4. The method of clause 3, further comprising: obtaining, using the orchestrator conversational AI, at least one input classification by classifying the one or more inputs, and selecting, using the orchestrator conversational AI and as the set of expert conversational AIs, any of the one or more expert conversational AIs associated with the at least one input classification.

Clause 5. The method of clause 4, wherein the at least one input classification comprises at least one of a data type, a data topic, an answer quality indicator, a computational resource consumption indicator, or a latency indicator.

Clause 6. The method of any one of the clauses 1-5, wherein the one or more strategies comprise at least an inter-expert post-retrieval early termination strategy in which the orchestrator conversational AI is to: instruct at least a set of the one or more expert conversational AIs to each retrieve information and send one or more metrics of a set of metrics indicating similarity between the retrieved information and the one or more inputs to the orchestrator conversational AI, identify one or more experts in the set of expert conversational AIs that retrieved relevant information based at least on the set of metrics, instruct the one or more experts to generate at least a subset of the one or more responses, and determine the at least one answer based at least on the subset of the one or more responses.

Clause 7. The method of any one of the clauses 1-6, wherein the one or more strategies comprise at least an intra-expert post-retrieval early termination strategy in which the orchestrator conversational AI is to: instruct each expert conversational AI in a set of the one or more expert conversational AIs to generate one of the one or more responses only if the expert conversational AI determines that the expert conversational AI has retrieved information that is relevant to the one or more inputs.

Clause 8. The method of any one of the clauses 1-7, further comprising: selecting, using the orchestrator conversational AI, the one or more expert conversational AIs from a plurality of expert conversational AIs, any of the plurality of expert conversational AIs not selected to remain idle or perform early termination.

Clause 9. The method of any one of the clauses 1-8, wherein the method is performed by at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

Clause 10. One or more processors comprising processing circuitry to: implement a first chatbot that is to at least: receive results generated by a set of second chatbots in response to one or more prompts provided to the set of second chatbots by the first chatbot; and generate a response to input received by the first chatbot based at least on a portion of the results.

Clause 11. The one or more processors of clause 10, wherein a plurality of second chatbots comprises the set of second chatbots and a set of remaining chatbots that are not included in the set of second chatbots, and the first chatbot is to at least: select the set of second chatbots from the plurality of second chatbots; and cause the set of second chatbots to perform retrieval augmented generation (RAG) while the set of remaining chatbots remain idle.

Clause 12. The one or more processors of clause 10 or 11, wherein the first chatbot is to at least: instruct each chatbot in a plurality of chatbots comprising the set of second chatbots to generate results only if the chatbot has retrieved information that is relevant to at least one prompt provided to the chatbot.

Clause 13. The one or more processors of any one of the clauses 10-12, wherein the first chatbot is to at least: provide a plurality of prompts comprising the one or more prompts to a plurality of chatbots comprising the set of second chatbots; instruct each chatbot in the plurality of chatbots to obtain information and provide one or more scores to the first chatbot indicating how relevant the information is to any of the plurality of prompts provided to the chatbot; select the set of second chatbots based at least on the one or more scores provided by each chatbot in the plurality of chatbots; and instruct the set of second chatbots to generate the results.

Clause 14. The one or more processors of any one of the clauses 10-13, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

Clause 15. A system comprising one or more processors to: use one or more neural networks to provide a plurality of inputs to a plurality of conversational Artificial Intelligences (AIs); and generate output based at least on results generated by the plurality of conversational AIs in response to the plurality of inputs.

Clause 16. The system of clause 15, wherein the one or more processors are to: select the plurality of conversational AIs from a collection of conversational AIs, the collection comprising a set of unselected conversational AIs that are not included in the plurality of conversational AIs, the plurality of conversational AIs to generate the results while the set of unselected conversational AIs are to remain idle.

Clause 17. The system of clause 15 or 16, wherein the one or more processors are to: instruct each of the plurality of conversational AIs to retrieve information, and generate at least a portion of the results after the information retrieved by the conversational AI is determined to be relevant to at least one of the plurality of inputs provided to the conversational AI.

Clause 18. The system of any one of the clauses 15-17, wherein the one or more processors are to: instruct the plurality of conversational AIs to generate the results after determining one or more relevance metrics calculated by the plurality of conversational AIs indicate the plurality of conversational Ais have retrieved relevant information.

Clause 19. The system of clause 18, wherein the one or more processors are to: generate one or more classifications associated with at least one user input; select the plurality of conversational AIs based at least on the one or more classifications; and generate the plurality of inputs based at least on the at least one user input.

Clause 20. The system of any one of the clauses 15-19, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

1. A method comprising:
selecting, by an orchestrator conversational Artificial Intelligence (AI), multiple expert conversational AIs from a plurality of expert conversational AIs, based at least in part, on one or more inputs obtained by the orchestrator conversational AI;
causing one or more expert AIs of the selected multiple expert conversational AIs to retrieve information from one or more data sources;
causing different ones of the selected multiple expert conversational AIs to generate multiple responses, one or more of the multiple responses to be generated based at least in part on at least a portion of the information retrieved by at least a portion of the one or more expert AIs;
determining, by the orchestrator conversational AI, at least one answer to the one or more inputs based at least on the multiple responses; and
causing at least one of audible or visual presentation of the at least one answer.

2. The method of claim 1, wherein determining the at least one answer based at least on the multiple responses comprises selecting a relevant portion of the multiple responses, and determining the at least one answer based at least on the relevant portion.

3. The method of claim 1, further comprising:
using, by the orchestrator conversational AI or the one or more expert Als, relevance of the information retrieved by the one or more expert AIs to determine whether to terminate generation of a response by any of the one or more expert AIs, wherein the portion of the one or more expert AIs is to include any of the one or more expert AIs determined not to be terminated.

4. The method of claim 1, further comprising:
obtaining, using the orchestrator conversational AI, at least one input classification by classifying the one or more inputs; and
selecting, using the orchestrator conversational AI and as the multiple of expert conversational Als, any of the plurality of expert conversational AIs associated with the at least one input classification.

5. The method of claim 4, wherein the at least one input classification comprises at least one of a data type, a data topic, an answer quality indicator, a computational resource consumption indicator, or a latency indicator.

6. The method of claim 1, further comprising:
sending, by the one or more expert AIs, one or more metrics of a set of metrics to the orchestrator conversational AI, the one or more metrics indicating similarity between the retrieved information and the one or more inputs;
identifying, by the orchestrator conversational AI, as the portion of the one or more expert AIs any of the one or more expert AIs that retrieved relevant information based at least on the set of metrics; and
instructing, by the orchestrator conversational AI, the portion of the one or more expert AIs to generate the one or more of the multiple responses.

7. The method of claim 1, wherein the orchestrator conversational AI is to instruct each expert conversational AI in the portion of the one or more expert AIs to generate one of the one or more of the multiple responses only if the expert conversational AI determines that the expert conversational AI has retrieved information that is relevant to the one or more inputs.

8. The method of claim 1, wherein any of the plurality of expert conversational AIs not selected by the orchestrator conversational AI are to remain idle or perform early termination.

9. The method of claim 1, wherein the method is performed by at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or a system implemented at least partially using cloud computing resources.

10. One or more processors comprising processing circuitry to:
implement a first chatbot that is to at least:
receive results generated by a set of second chatbots in response to one or more prompts provided to the set of second chatbots by the first chatbot; and
generate a response to input received by the first chatbot based at least on a portion of the results.

11. The one or more processors of claim 10, wherein a plurality of second chatbots comprises the set of second chatbots and a set of remaining chatbots that are not included in the set of second chatbots, and the first chatbot is to at least:
select the set of second chatbots from the plurality of second chatbots; and
cause the set of second chatbots to perform retrieval augmented generation (RAG) while the set of remaining chatbots remain idle.

12. The one or more processors of claim 10, wherein the first chatbot is to at least:
instruct each chatbot in a plurality of chatbots comprising the set of second chatbots to generate results only if the chatbot has retrieved information that is relevant to at least one prompt provided to the chatbot.

13. The one or more processors of claim 10, wherein the first chatbot is to at least:
provide a plurality of prompts comprising the one or more prompts to a plurality of chatbots comprising the set of second chatbots;
instruct each chatbot in the plurality of chatbots to obtain information and provide one or more scores to the first chatbot indicating how relevant the information is to any of the plurality of prompts provided to the chatbot;
select the set of second chatbots based at least on the one or more scores provided by each chatbot in the plurality of chatbots; and
instruct the set of second chatbots to generate the results.

14. The one or more processors of claim 10, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or a system implemented at least partially using cloud computing resources.

15. A system comprising one or more processors to:
use one or more neural networks to provide a plurality of inputs to a plurality of conversational Artificial Intelligences (AIs); and
generate output based at least on results generated by the plurality of conversational AIs in response to the plurality of inputs.

16. The system of claim 15, wherein the one or more processors are to:
select the plurality of conversational AIs from a collection of conversational AIs, the collection comprising a set of unselected conversational AIs that are not included in the plurality of conversational AIs, the plurality of conversational AIs to generate the results while the set of unselected conversational Als are to remain idle.

17. The system of claim 15, wherein the one or more processors are to:
instruct each of the plurality of conversational AIs to retrieve information, and generate at least a portion of the results after the information retrieved by the conversational AI is determined to be relevant to at least one of the plurality of inputs provided to the conversational AI.

18. The system of claim 15, wherein the one or more processors are to:
instruct the plurality of conversational AIs to generate the results after determining one or more relevance metrics calculated by the plurality of conversational AIs indicate the plurality of conversational Ais have retrieved relevant information.

19. The system of claim 18, wherein the one or more processors are to:
generate one or more classifications associated with at least one user input;
select the plurality of conversational AIs based at least on the one or more classifications; and
generate the plurality of inputs based at least on the at least one user input.

20. The system of claim 15, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
